(19) United States
(12) Patent Application Publication
(10) Pub. No.: US 2026/0273466 A1
(43) Pub. Date: Sep. 17, 2026

(54) AN INTEGRATED RESOURCE RECOVERY AND CO-TREATMENT SYSTEM OF DESALINATION BRINE AND FLUE GAS VIA WASTE BRINE ELECTROLYSIS AND SUSTAINABLE CO2 MINERALISATION (FROM BRINE TO NEWSEAWATER)

(71) Applicant: NANYANG TECHNOLOGICAL UNIVERSITY, Singapore (SG)

(72) Inventors: Wei Han TU, Singapore (SG); Wei Ping CHAN, Singapore (SG); Grzegorz LISAK, Singapore (SG)

(21) Appl. No.: 19/472,255

(22) PCT Filed: Apr. 3, 2024
(86) PCT No.: PCT/SG2024/050220

§ 371 Date: Oct. 3, 2025

(30) Foreign Application Priority Data
Apr. 3, 2023 (SG) 10202300907V

(51) Int. Cl. B01D 53/96; B01D 53/62; B01D 53/75; B01D 53/78; C25B 1/46; C25B 9/15; C25B 9/23

(52) U.S. Cl. CPC B01D 53/965; B01D 53/62; B01D 53/75; B01D 53/78; C25B 1/46; C25B 9/15; C25B 9/23; B01D 2251/304; B01D 2251/306; B01D 2251/404; B01D 2251/604; B01D 2257/504

(57) ABSTRACT

Disclosed herein is a process for treating a desalination-rejected brine and a flue gas, the process comprising the steps of (a) subjecting a desalination-rejected brine to reaction with an alkali metal hydroxide to provide a precipitate comprising magnesium hydroxide and an alkaline brine, and separating the precipitate from the alkaline brine, (b) bubbling a flue gas comprising CO₂ into the alkaline brine to provide a precipitate comprising calcium carbonate and a softened brine, and separating the precipitate from the softened brine, (c) subjecting the softened brine to acidification by addition of an acid to provide an acidified brine having a pH of from 1 to 5, (d) providing the acidified brine to an anode compartment of a flow electrochemical cell and providing a seawater and/or a reclaimed seawater to a cathode compartment of the flow electrochemical cell and generating chlorine gas, an anode brine, hydrogen gas and an alkaline cathode brine, and (e) mixing the anode brine and the entirety or a third portion of the alkaline cathode brine together and subjecting the mixture to a dechlorination reaction to provide a reclaimed seawater. Also disclosed herein is an apparatus for treating a desalination-rejected brine and a flue gas.

### FIELD OF INVENTION

The present disclosure generally relates to treatments of desalination brine and flue gas, and more particularly relates to processes and apparatuses for treating a desalination-rejected brine and a flue gas via waste brine electrolysis and sustainable CO₂ mineralisation.

### BACKGROUND

The listing or discussion of a prior-published document in this specification should not necessarily be taken as an acknowledgement that the document is part of the state of the art or is common general knowledge.

The negative environmental and ecological impacts of direct desalination brine discharge are increasingly well understood. In response, a series of brine outfall mitigation designs have been proposed to address the high salinity, high temperature, and toxic components in desalination brine. However, with such designs and alternative brine discharge methods, the energy and cost per cubic metre are expensive relative to the cost of desalination. Recently, resource recovery from desalination brine has been increasingly seen as an economically viable strategy to reduce direct brine discharge while extracting high-value components.

Seawater or desalination brine cannot be directly used in chlor-alkali plants due to three main factors: the low chloride concentration; the neutral pH condition; and the presence of impurities. Firstly, the minimum Cl concentration of chlor-alkali electrolysis without suffering any effect on current efficiency (94%) is 136.5 g/L ([NaCl]=225 g/L) (O'Brien, T. F. et al., Handbook of Chlor-Alkali Technology: Volume I: Fundamentals, Volume II: Brine Treatment and Cell Operation, Volume III: Facility Design and Product Handling, Volume IV: Operations, Volume V: Corrosion, Environmental Issues, and Future Developments; Springer US, 2005). Comparing against the chloride concentration in seawater (18.0 g/L) and desalination brine (33.7 g/L, see Table 1), the low Cl⁻ concentration limits the current efficiency to approximately 82% (seawater) and 90% (1 M NaCl) at neutral conditions (Lim, T. et al., Nat. Commun. 2020, 11, 412; and Han, S. et al., J. Ind. Eng. Chem. 2022, 108, 514-521). The ion exchange membrane can be permanently damaged in NaCl concentration under 17% as the osmotic pressure on the ion exchange membrane is too large when paired with 30-32% NaOH solution (O'Brien, T. F. et al., Handbook of Chlor-Alkali Technology: Volume I: Fundamentals, Volume II: Brine Treatment and Cell Operation, Volume III: Facility Design and Product Handling, Volume IV: Operations, Volume V: Corrosion, Environmental Issues, and Future Developments; Springer US, 2005). This increases stress- and fatigue-induced damage, resulting in a decrease in the operational lifetime of membrane electrolyser.

TABLE 1
Physicochemical properties of seawater and desalination brine.

| Parameters | Seawater | Desalination brine |
|---|---|---|
| Sodium (mg/L) | 9080 ± 775 | 16578 ± 502 |
| Magnesium (mg/L) | 1432 ± 209 | 2177 ± 100 |
| Potassium (mg/L) | 439 ± 323 | 977 ± 223 |
| Calcium (mg/L) | 438.8 ± 66.2 | 702 ± 20 |
| Strontium (mg/L) | 6.9 ± 1.1 | 11.6 ± 0.7 |
| Chloride (mg/L) | 18016 ± 1461 | 33766 ± 113 |
| Sulfate (mg/L) | 2588 ± 284 | 4104 ± 327 |
| Bromide (mg/L) | 62.1 ± 20.9 | 90 ± 12 |
| TDS (mg/L) | 31995 ± 1412 | 55982 ± 2122 |
| Conductivity (mS/cm) | 42.0 ± 4.3 | 87.3 ± 2.7 |
| pH | 7.70 ± 0.1 | 7.88 ± 0.1 |
| TOC (mg/L) | 3.8 ± 1.3 | 5.2 ± 0.1 |
| TN (mg/L) | 3.6 ± 1.5 | 6.9 ± 1.9 |

Secondly, the presence of magnesium and calcium ions in the cathode complicates tradition chlor-alkali electrolysis as the cations are deposited as hydroxide precipitates on the electrode, coating a high resistance layer which significantly reduces the active catalytic surface of the cathode. In the anode, the Group II elements also precipitate on or in the ion-exchange membrane as the high pH gradient across the membrane causes some precipitation on the anode side.

Lastly, favourable pH has to be maintained in both the cathode and the anode to ensure high hydrogen evolution reaction (HER) and chlorine evolution reaction (CER) efficiencies. The anolyte is typically kept between pH 2-4 as it favours chlorine gas formation instead of hypochlorite and anode product selectivity. Oxygen evolution (OER) and CER were competing reactions due to the presence of both water and chloride. As OER is dependent on H⁺ (i.e. pH), lower pH favours CER over OER. The OER and CER redox reactions are as shown below:

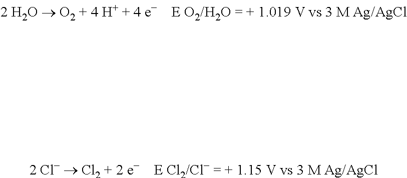

Meanwhile, the operational catholyte pH were typically kept at pH 14.7 (30-32% NaOH). This catholyte is the most optimal state for both conductivity and minimal energy for subsequent NaOH precipitation, which is crucial to reduce the operational cost of NaOH precipitation. Lastly, a series of chemical is necessary to lower the magnesium (<50 ppb), calcium (<50 ppb), and sulfate ions (<4-8 g/L) below the impurity limit to prevent precipitation on and in the electrode and membrane. Meeting the operational requirements of chlor-alkali plants minimises the energy loss and operational cost due to precipitate resistance.

Some studies have explored converting desalination brine into a feedstock for the chlor-alkali process as the TDS of seawater reverse osmosis (SWRO) desalination brine is only about 3-3.5 times lower than the chlor-alkali process (220-320 g/L NaCl solution). A comprehensive system to convert desalination brine into chlor-alkali feed has been proposed and simulated by Du et al. (Du, F. et al., Environ. Sci. Technol. 2018, 52, 5949-5958). Their process mechanically, chemically (Melián-Martel, N. et al., Desalination 2011, 281, 35-41), and electrochemically (Casas Garriga, S. Valorization of Brines in the Chlor-Alkali Industry. Integration of Precipitation and Membrane Processes. Ph.D. Thesis, Universitat Politécnica de Catalunya, 2011) treated and concentrated desalination brine into usable anolyte feed. Choi et al. have expanded on Du et al.'s work and focused on using sodium hydroxide for flue gas CO₂ mineralisation process (Choi, W. Y. et al., Desalination 2021, 509, 115068; and Bang, J.-H. et al., Minerals 2017, 7, 207). The process design partially utilised the sodium hydroxide to produce magnesium and calcium carbonate for brine and flue gas treatment.

However, their economic analysis indicated that the evaporator was more energy intensive than the main electrolysis of brine. The high energy demand can lead to excess greenhouse gas emission as an additional environmental impact of consequence. Alterative mechanical vapour compression has been proposed and investigated in Du et al.'s work, but the pre-treatment processes still accounted for a quarter of the total energy demand of the system. A large amount of waste brine was also produced through nanofiltration concentrate and purge solution, which was necessary to prevent the sulfate poisoning of electrodes. Although the direct discharge of desalination brine could be avoided, substantial process-generated brine still contributed to environmental contamination whether discharge on land or into the sea.

An alternative electrochemical resource recovery route is the electrodialysis with bipolar membrane. This method can electrochemically extract acid and alkali streams from desalination brine stream sandwiched by an anion exchange membrane and a cation exchange membrane. However, the acid and alkali streams are only 0.1-2 M. This is significantly lower than chlor-alkali process (7.5 M), which requires more energy to precipitate NaOH. Electrodialysis also uses 9 V at 0.5 kA/m² with 50-88% current efficiency (Reig, M. et al., Desalination 2016, 398, 87-97). Comparing to the high current efficiency (94-98%) in chlor-alkali process, the thermodynamic inefficiency in the electrodialysis cell increases the overall operational cost while not producing sufficient hydroxide to offset CO₂ emitted. Hence, a modified chlor-alkali process for desalination brine is needed to leverage on product recovery and CO₂ capture for negative emissions.

Therefore, to manage global warming potential and aquatic toxicity, there exists a need for a new economically feasible system to be designed for sustainable development.

### SUMMARY OF INVENTION

Aspects and embodiments of the invention will now be described by reference to the following numbered clauses.
1. A process for treating a desalination-rejected brine and a flue gas, the process comprising the steps of:
(a) subjecting a desalination-rejected brine to reaction with an alkali metal hydroxide to provide a precipitate comprising magnesium hydroxide and an alkaline brine, and separating the precipitate from the alkaline brine;
(b) bubbling a flue gas comprising CO₂ into the alkaline brine to provide a precipitate comprising calcium carbonate and a softened brine, and separating the precipitate from the softened brine;
(c) subjecting the softened brine to acidification by addition of an acid to provide an acidified brine having a pH of from 1 to 5;
(d) providing the acidified brine to an anode compartment of a flow electrochemical cell and providing a seawater and/or a reclaimed seawater to a cathode compartment of the flow electrochemical cell and generating:
   chlorine gas and an anode brine from an electrochemical chlorine evolution reaction; and
   hydrogen gas and an alkaline cathode brine from an electrochemical hydrogen evolution reaction, optionally where a first portion of the alkaline chloride brine is used in step (a) of the process and/or a second portion of the alkaline chloride brine is used in step (b) of the process; and
(e) mixing the anode brine and the entirety or a third portion of the alkaline cathode brine together and subjecting the mixture to a dechlorination reaction to provide a reclaimed seawater, optionally wherein a portion of the reclaimed seawater is provided to the cathode compartment in step (c) of the process.
2. The process according to Clause 1, wherein the process further comprises the steps of:
(a′) subjecting a seawater and/or a reclaimed seawater to reaction with an alkali metal hydroxide to provide a precipitate comprising magnesium hydroxide and an alkaline seawater, and separating the precipitate from the alkaline seawater, optionally wherein the pH of the alkaline seawater is from 11.5 to 13; and
(b′) bubbling a flue gas comprising CO₂ into the alkaline seawater to provide a precipitate comprising calcium carbonate and a softened seawater with a pH of from 8 to 10, and separating the precipitate from the softened seawater,
   where the softened seawater is used in place of, or in addition to, the seawater in step (d) of the process according to Clause 1.
3. The process according to Clause 1 or Clause 2, wherein one or both of the following apply:
(aa) the alkali metal hydroxide is one or both of sodium hydroxide and potassium hydroxide; and
(bb) the pH of the alkaline brine step in (a) of Clause 1 is from 11.5 to 13.
4. The process according any one of the preceding clauses, wherein when the second portion of the second portion of the alkaline chloride brine is used in step (b) of the process it is used to capture CO₂ in the flue gas as sodium bicarbonate.
5. The process according to any one of the preceding clauses, wherein one or both of the following apply:
(A) the acid in step (c) of Clause 1 is a mineral acid (e.g. hydrochloric acid); and
(B) the pH of the acidified brine in step (c) of Clause 1 is from 2 to 4.
6. The process according to any one of the preceding clauses, wherein the dechlorination reaction is conducted using one or more of sparging with a suitable gas and reaction with a suitable dechloriation reagent (e.g. NaHSO₃).
7. The process according to any one of the preceding clauses, wherein one or more of the following apply:
(ia) the weight-to-weight ratio of the desalination-rejected brine to the alkali metal hydroxide in dry weight form is from 125:1 to 125:2;
(iia) the weight-to-weight ratio of the alkaline brine to the flue gas is from 40:1 to 100:1; and
(iiia) the weight-to-weight ratio of the softened brine to acid is from 700:1 to 1000:1.
8. The process according to any one of the preceding clauses, wherein one or more of the following apply:
(ib) the precipitate comprising magnesium hydroxide further comprises calcium hydroxide; and
(iib) the precipitate comprising calcium carbonate further comprises strontium carbonate.
9. An apparatus for treating a desalination-rejected brine and a flue gas, the apparatus comprising:
   a first reactor configured to receive a desalination brine and an alkali metal hydroxide to provide a first precipitate and an alkaline brine, and a first separation means or apparatus to separate the first precipitate from the alkaline brine;
   a second reactor configured to receive the separated alkaline brine and a flue gas, where the second reactor is configured to allow the flue gas to be bubbled through the alkaline brine to provide a second precipitate and a softened brine, and a second separation means or apparatus to separate the second precipitate from the softened brine;
   a third reactor configured to receive the softened brine and an acid in amounts to provide an acidified brine;
   a flow electrochemical cell comprising:
      an anode compartment for receiving the acidified brine;
      a cathode compartment for receiving a seawater and/or a reclaimed seawater; and
      an ion-selective membrane between the anode and cathode compartments, wherein the flow electrochemical cell is configured to provide:
   chlorine gas and an anode brine from the acidified brine; and
   hydrogen gas and an alkaline cathode brine from the seawater and/or the reclaimed seawater; and
   a dechlorination reactor to receive the anode brine and at least a portion of the alkaline cathode brine and provide a reclaimed seawater.
10. The apparatus according to Clause 9, wherein the apparatus further comprises a fluid pathway to provide at least part of the alkaline cathode brine to the first reactor.
11. The apparatus according to Clause 9 or Clause 10, wherein the apparatus further comprises a fluid pathway to provide at least part of the reclaimed seawater to the cathode compartment.
12. The apparatus according to any one or Clauses 9 to 11, wherein:
   the first reactor is divided into:
      a first portion that is configured to receive a desalination brine and an alkali metal hydroxide to provide a first precipitate and an alkaline brine; and
      a second portion that is configured to receive a seawater and/or a reclaimed seawater and an alkali metal hydroxide to provide a first' precipitate and an alkaline seawater;
   the first separation means or apparatus is divided into a first portion configured to separate the first precipitate from the alkaline brine and a second portion configured to separate the first' precipitate from the alkaline seawater;
   the second reactor is divided into:
      a first portion configured to receive the separated alkaline brine and a flue gas, where the first portion of the second reactor is configured to allow the flue gas to be bubbled through the alkaline brine to provide a second precipitate and a softened brine; and
      a second portion configured to receive the separated seawater brine and a flue gas, where the second portion of the second reactor is configured to allow the flue gas to be bubbled through the alkaline brine to provide a second' precipitate and a softened seawater;
   the second separation means or apparatus is divided into a first portion configured to separate the second precipitate from the softened brine and a second portion configured to separate the second' precipitate from the softened seawater; and
   a first fluid pathway to provide the softened brine to the third reactor and a second fluid pathway to provide the softened seawater to the cathode compartment.

### BRIEF DESCRIPTION OF THE DRAWINGS

FIG. 1 depicts an apparatus for treating a desalination-rejected brine and a flue gas. The units refers to the mass flow units. The numbers provided in bold are the mass flow between each reaction, given in kg.

FIG. 2 depicts a multi-waste treatment and resource recovery system flow diagram. Starting from the inlet (left to right), R1 is the hydroxide precipitation, R2 is CO₂ mineralisation, and R3 is brine acidification. In between the reactors, precipitates are recovered via filtration. R2 filtrate and R3 are used as catholyte and anolytes, respectively. Hydrogen and chlorine are extracted from the membrane electrolyser. The catholyte containing NaOH is circularised to R1. The depleted anolyte is dechlorinated and mixed with cathode output to revert into a desalination plant or discharge into the sea. Grey colour streams are pre-treatment processes, and black streams are for electrochemical processes. The width of the arrow indicates the expected mass flows.

FIG. 3 depicts a graphical representation of the composition of Mg(OH)₂ (a) and CaCO₃ (b) based on R1 pH precipitated from seawater (SW) and desalination brine (DB). All precipitates were washed 5 times and triplicate averaged.

FIG. 4 depicts the Mg(OH)₂ composition after 10 wash cycles.

FIG. 5 depicts the elemental analysis of pre-treated seawater and desalination brine of the present Mg (a), Ca (b) and Sr (c) contents while comparing across untreated, R1-treated, R2-treated, and R3-treated.

FIG. 6 depicts that the scanning electron microscopy (SEM) image of Mg(OH)₂ (a) shows a wide range of agglomerate size, ranging from <1 to 5 μm. SEM image of CaCO₃ (b) depicts regular particles of 10 to 20 μm.

FIG. 7 depicts x-ray diffraction (XRD) of Mg(OH)₂ (a) and CaCO₃ (b) precipitated at R1 pH 13.

FIG. 8 depicts electrochemical analysis of desalination brine at the anode. (a) Linear scanning voltammetry (LSV) curves of controls (1 M NaCl at pH 7 and pH 2), desalination brine anolyte-desalination brine catholyte (DB-DB) setup, and desalination brine anolyte-seawater catholyte (DB-SW) setup, using Ir/Ru MMO electrodes. The dotted lines are iR compensated LSV curve. (b) Cl₂ selectivity of prepared solutions were investigated. Faradaic efficiency (FE) analysis for CER at different conditions. All data presented are triplicate averaged.

FIG. 9 depicts electrochemical analysis of desalination brine at HER. (a) LSV curves of controls (1 M NaCl at pH 7 and pH 2), DB-DB and DB-SW setups, using Ni electrodes. Dotted lines are iR compensated LSV curve. (b) H₂ selectivity at different current densities were investigated to observe any alternate product formation. FE analysis for HER at different current densities. All data presented are triplicate averaged.

FIG. 10 depicts chronoamperometry curves. Treated desalination brine anolyte and seawater catholytes were performed at high current densities for 30 min (a) and over 7 h (b).

FIG. 11 depicts the decrease in chloride concentration to reach seawater level. The chloride concentration in desalination brine during pre-treatment processes (left) and after electrolysis (right) decreased to below seawater Cl concentration. The electrode surface area was 2 cm².

FIG. 12 depicts FE of chlorine evolution reaction (CER) performed with acidified SW (R3)-SW (R2) system showed decreased FE by ^{~}10% compared to DB-SW. The effective FE computed by chloride removal after DB is converted into SW is 70.9%. *The calculation based on the percentage of change in chloride concentration (measured with ion chromatography (IC)) divided by the number of moles of electrons used.

FIG. 13 depicts Life Cycle Analysis (LCA) graphs of climate change, GWP 100 (a) and relative marine aquatic ecotoxicity (b) were illustrated based on environmental indicator and modified freshwater toxicity.

FIG. 14 depicts a flow diagram comprising of sub-systems and processes analysed in the sustainability study.

### DETAILED DESCRIPTION OF THE EMBODIMENTS

It has been surprisingly found that a multi-waste treatment integrated process that effectively deals with desalination-rejected brine and industrial flue gas while simultaneously generating high-value products for a profit-positive carbon capture and green hydrogen production technology can be generated through the combination of softening the desalination-rejected brine (in part) with the flue gas and by electrolysis. Desalination-rejected brine can be reduced via an electrolysis-based desalination as chloride is removed via a chlorine evolution reaction and sodium is removed through electrodialysis. CO₂ in the industrial flue gas can be captured through alkali brine to produce solid CaCO₃ and aqueous NaHCO₃. Hydrogen and chlorine gas will be generated through the brine electrolysis process. The resulting anolyte feed, the NEWSeawater, can be safely discharged into the sea after neutralisation and dechlorination, or reverted into a desalination plant for further water recovery.

In a first aspect of the invention, there is provided a process for treating a desalination-rejected brine and a flue gas, the process comprising the steps of:
(a) subjecting a desalination-rejected brine to reaction with an alkali metal hydroxide to provide a precipitate comprising magnesium hydroxide and an alkaline brine, and separating the precipitate from the alkaline brine;
(b) bubbling a flue gas comprising CO₂ into the alkaline brine to provide a precipitate comprising calcium carbonate and a softened brine, and separating the precipitate from the softened brine;
(c) subjecting the softened brine to acidification by addition of an acid to provide an acidified brine having a pH of from 1 to 5;
(d) providing the acidified brine to an anode compartment of a flow electrochemical cell and providing a seawater and/or a reclaimed seawater to a cathode compartment of the flow electrochemical cell and generating:
   chlorine gas and an anode brine from an electrochemical chlorine evolution reaction; and
   hydrogen gas and an alkaline cathode brine from an electrochemical hydrogen evolution reaction, optionally where a first portion of the alkaline chloride brine is used in step (a) of the process and/or a second portion of the alkaline chloride brine is used in step (b) of the process; and
(e) mixing the anode brine and the entirety or a third portion of the alkaline cathode brine together and subjecting the mixture to a dechlorination reaction to provide a reclaimed seawater, optionally wherein a portion of the reclaimed seawater is provided to the cathode compartment in step (c) of the process.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

The process may further comprise the steps of:
(a′) subjecting a seawater and/or a reclaimed seawater to reaction with an alkali metal hydroxide to provide a precipitate comprising magnesium hydroxide and an alkaline seawater, and separating the precipitate from the alkaline seawater, optionally wherein the pH of the alkaline seawater is from 11.5 to 13; and
(b′) bubbling a flue gas comprising CO₂ into the alkaline seawater to provide a precipitate comprising calcium carbonate and a softened seawater with a pH of from 8 to 10, and separating the precipitate from the softened seawater,
   where the softened seawater is used in place of, or in addition to, the seawater in step (d) of the process as described above.

In embodiments of the invention, the alkali metal hydroxide may be one or both of sodium hydroxide and potassium hydroxide. In embodiments of the invention, the pH of the alkaline brine step in (a) of the process may be from 11.5 to 13.

In embodiments of the invention when the second portion of the second portion of the alkaline chloride brine is used in step (b) of the process it may be used to capture CO₂ in the flue gas as sodium bicarbonate.

In embodiments of the invention, one or both of the following may apply:
(A) the acid in step (c) of the process may be a mineral acid (e.g. hydrochloric acid); and
(B) the pH of the acidified brine in step (c) of the process may be from 2 to 4.

In embodiments of the invention, the dechlorination reaction may be conducted using one or more of sparging with a suitable gas and reaction with a suitable dechloriation reagent (e.g. NaHSO₃).

Any suitable mass ratio between the various components may be used. For example, the one or more of the following apply:
(ia) the weight-to-weight ratio of the desalination-rejected brine to the alkali metal hydroxide in dry weight form may be from 125:1 to 125:2;
(iia) the weight-to-weight ratio of the alkaline brine to the flue gas may be from 40:1 to 100:1; and
(iiia) the weight-to-weight ratio of the softened brine to acid may be from 700:1 to 1000:1.

As will be appreciated, the precipitates produced in the process may include further components. For example:
(ib) the precipitate comprising magnesium hydroxide may further comprise calcium hydroxide; and/or
(iib) the precipitate comprising calcium carbonate may further comprise strontium carbonate.

In a second aspect of the invention, there is provided an apparatus for treating a desalination-rejected brine and a flue gas, the apparatus comprising:
a first reactor configured to receive a desalination brine and an alkali metal hydroxide to provide a first precipitate and an alkaline brine, and a first separation means or apparatus to separate the first precipitate from the alkaline brine;
a second reactor configured to receive the separated alkaline brine and a flue gas, where the second reactor is configured to allow the flue gas to be bubbled through the alkaline brine to provide a second precipitate and a softened brine, and a second separation means or apparatus to separate the second precipitate from the softened brine;
a third reactor configured to receive the softened brine and an acid in amounts to provide an acidified brine;
a flow electrochemical cell comprising:
   an anode compartment for receiving the acidified brine;
   a cathode compartment for receiving a seawater and/or a reclaimed seawater; and
   an ion-selective membrane between the anode and cathode compartments, wherein the flow electrochemical cell is configured to provide:
chlorine gas and an anode brine from the acidified brine; and
hydrogen gas and an alkaline cathode brine from the seawater and/or the reclaimed seawater; and
a dechlorination reactor to receive the anode brine and at least a portion of the alkaline cathode brine and provide a reclaimed seawater.

The apparatus disclosed herein may further comprise a fluid pathway to provide at least part of the alkaline cathode brine to the first reactor.

In certain embodiments, the apparatus may further comprise a fluid pathway to provide at least part of the reclaimed seawater to the cathode compartment.

In yet further embodiments of the invention, the first reactor may be divided into:
a first portion that is configured to receive a desalination brine and an alkali metal hydroxide to provide a first precipitate and an alkaline brine; and
a second portion that is configured to receive a seawater and/or a reclaimed seawater and an alkali metal hydroxide to provide a first' precipitate and an an alkaline seawater;
the first separation means or apparatus is divided into a first portion configured to separate the first precipitate from the alkaline brine and a second portion configured to separate the first' precipitate from the alkaline seawater;
the second reactor is divided into:
   a first portion configured to receive the separated alkaline brine and a flue gas, where the first portion of the second reactor is configured to allow the flue gas to be bubbled through the alkaline brine to provide a second precipitate and a softened brine; and
   a second portion configured to receive the separated seawater brine and a flue gas, where the second portion of the second reactor is configured to allow the flue gas to be bubbled through the alkaline brine to provide a second' precipitate and a softened seawater;
the second separation means or apparatus is divided into a first portion configured to separate the second precipitate from the softened brine and a second portion configured to separate the second' precipitate from the softened seawater; and
a first fluid pathway to provide the softened brine to the third reactor and a second fluid pathway to provide the softened seawater to the cathode compartment.

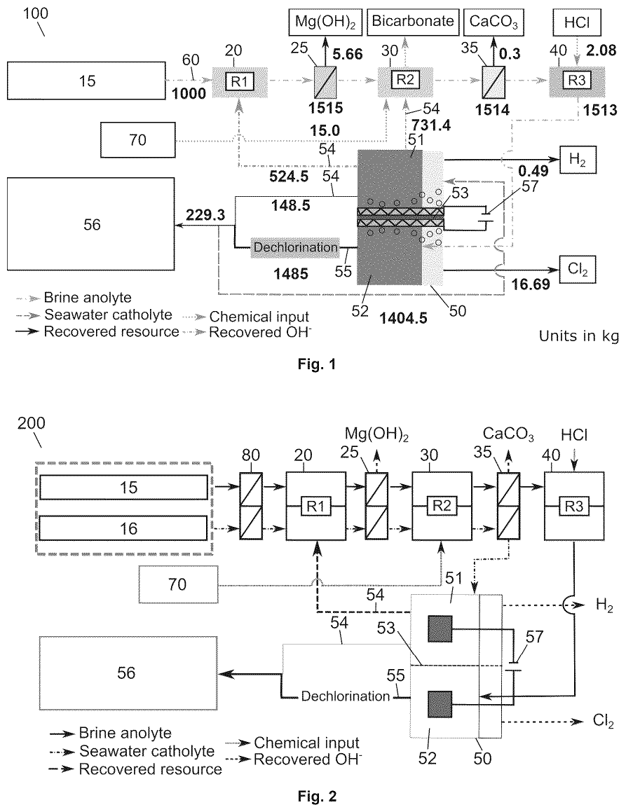

A first apparatus and method thereof may be described based on FIG. 1. The apparatus 100, contains a first 20, second 30, and third reactor 40 in series. The first reactor 20 is in fluid communication with the second reactor 30 and fluid passing from the first reactor 20 to the second reactor 30 will pass through a first separation means or apparatus 25 (e.g. a filtering mechanism). The second reactor 30 is in fluid communication with the third reactor 40 and fluid passing from the second reactor 30 to the third reactor 40 will pass through a second separation means or apparatus 35 (e.g. a filtering mechanism). In the configuration of this figure, a desalination brine source 15 may be in fluid communication with the first reactor 20, which is configured to receive sodium hydroxide-either by the insertion of solid sodium hydroxide (or a solution thereof) from a pristine source, or from a hydroxide solution from an electrolyser 50 portion of the apparatus, as discussed in more detail below. A flue gas source 70 may be in fluid communication with the second reactor 30, which may also receive a hydroxide solution from the electrolyser 50 portion of the apparatus 100. The third reactor 40 is configured to receive an acid (e.g. HCl) and is in fluid communication with an anode compartment 52 of an electrolyser 50.

The electrolyser 50 is composed of:
a cathode compartment 51, configured to receive reclaimed seawater (or seawater) from a suitable source (or from the apparatus itself when the apparatus is in use);
an anode compartment 52 to receive acidified brine from the third reactor 40; and
an ion-selective membrane 53, along with a power source 57 to drive the desired reactions. The cathode compartment's discharged alkaline material 54 is in fluid communication with the first reactor 20 and the anode compartment's discharged material 55 (with suitable portions going to each). Optionally, the compartment's discharged alkaline material may also be in fluid communication with the second reactor 30. The discharged alkaline material 54 and anode compartment's discharged material 55 are mixed and subjected to a dechlorination reaction to provide reclaimed seawater 56, which may be discharged or part may be fed back into the cathode compartment 51 to continue the cycle.

Any suitable ion-selective membrane may be used herein. For example, membranes of the Nafion type may be used herein.

In use, the desalination-rejected brine 60 is subjected to a two-stage softening process in the first 20 and second 30 reactors, where it is subjected to an alkali metal hydroxide and flue gas 70, respectively. In the first reactor 20, the reaction of the alkali metal hydroxide with the desalination-rejected brine provides an alkaline brine and a precipitate (e.g. Mg(OH)₂ and other components, such as Ca(OH)₂), which is then filtered out using the first separation means or apparatus 25 before passing into the second reactor 30. In the second reactor 30, the alkaline brine is subjected to the flue gas 70 to provide a precipitate and a softened brine, which are then separated by passage through the second separation means or apparatus 35 before passing into the third reactor 40. The calcium carbonate may not be the only precipitated component. In further embodiments, a portion of the cathode compartment's discharged alkaline material 54 may be fed into the second reactor 30 and this, along with the alkaline brine may also generate bicarbonate precipitates too.

In the third reactor 40, an acid (e.g. HCl) may be added to acidify the softened brine and this acidified brine may then be fed into the anode compartment 52 of the electrolyser 50, where it undergoes a chlorine evolution reaction, with chlorine gas being removed and stored. In the cathode compartment 51, reclaimed seawater (or possibly seawater in an initial cycle) is fed into the cathode compartment 51, which undergoes a hydrogen evolution reaction, with hydrogen gas being captured and the resulting cathode compartment's discharged alkaline material 54 (which is hydroxide rich) being fed in up to three directions. That is one portion may enter the second reactor 30 as discussed above, one portion may be sent to the first reactor 20 to act as the hydroxide source and the remaining portion may be mixed with the anode compartment's discharged material 55 and subjected to dechlorination to provide reclaimed seawater.

FIG. 2 depicts a similar apparatus 200 and method, except in this set-up the first reactor 20 is split into two compartments, as is the second reactor 30. This is because seawater may be subjected to the same reactions discussed above for these reactors, to provide a softened seawater (in alkaline form) that may be fed into the cathode compartment 51 of the electrolyser 50. As will be appreciated, the first 25 and second 35 separation means or apparatus will be split into two portions as well to allow for the separate handling of both desalination-rejected brine and seawater. As shown, in this configuration, the cathode compartment's discharged alkaline material 54 is not fed into the second reactor, though it is possible that this could be done.

Advantages associated with the process and apparatus disclosed herein include, but are not limited to the following.
Simultaneously treating two industrial waste streams, the desalination rejected brine and industrial flue gas, to minimise their environmental impact when, after treatment and resource recovery, they are emitted into the sea or the air, respectively.
Substantial energy saving by avoiding the extensive needs for the pre-concentration of waste brine to make the process more environmentally friendly and cost-effective.
Capture the CO₂ emitted from different types of stationary point sources such as natural gas or biomass power plant, anaerobic digester and Waste-to-Energy facilities which compensate (and potentially eliminate) the carbon footprint of the energy consumed during electrolysis.
Produce mineralised CO₂ as CaCO₃ which can be used as additives in construction materials and bicarbonate salts.
Produce multiple valuable commodities such as Mg(OH)₂, chlorine gas, bromine liquid and green (or yellow) hydrogen based on the sources of the electricity applied.
Provide the necessary chemicals, such as caustic brine and dissolved chlorine for pH adjustment and anti-biofoulant, respectively, for an effective SWRO desalination process and other related wastewater treatments.
Produce treated brine with TDS close to natural seawater as the NEWSeawater which can be recycled back for further SWRO desalination to produce more clean water before final disposal
The NEWSeawater can be discharged safely and sustainably back into the sea with minimal environmental impacts.

Further aspects and embodiment of the invention may include the following.
1. Use of an integrated multi-waste treatment and resource recovery system to extract valuable products from desalination brine and flue gas while producing waste output with significantly less environmental impact.
2. A set of processes for waste brine and industrial flue gas co-treatment and circularisation of electrolysis products with the distinctive features and properties of:
   a. sustainable and effective co-treatment of industrial waste streams;
   b. multiple high purity products recovery which include Mg(OH)₂ (≥85%), CaCO₃ (≥95%), H₂ (≥99%), and Cl₂ (≥95%) with relevant phase separation purification techniques (liquid-solid and liquid-gas);
   c. self-sufficient production of alkali brine (350 mol/m³ brine) for hydroxides precipitation, carbon capture and CO₂ mineralisation; and
   d. production of the NEWSeawater, softened and electrochemically desalinated brine, for possible further resource extraction (e.g., water, lithium, rubidium) or safe disposal.
3. A set of modified chlor-alkali brine electrolysis reactions with the properties and operating conditions of:
   a. high thermodynamic efficiency (~70%);
   b. effective multivalent ions removal through hydroxide precipitation and CO₂ mineralisation;
   c. lower catholyte concentration (pH 13 seawater) for balanced osmotic pressure;
   d. lower osmotic pressure for thinner and cheaper ion exchange membrane usage;
   e. low environmental impacts with CO₂ capture and NEWSeawater discharge; and
   f. low voltage (3-3.5 V) and higher current density (3-5 kA/m²) requirements.

Further aspects and embodiments of the invention will be discussed by reference to the following non-limiting examples.

### EXAMPLES

### Materials

Sodium chloride (NaCl, ≥99%), sodium hydroxide (NaOH, ≥99%), sodium iodide (NaI, anhydrous, ≥99.5%), sodium thiosulfate (Na₂S₂O₃, ≥99.5%), soluble starch powder (ACS, for iodometry), and hydrogen peroxide (H₂O₂, 30%) were purchased from Sigma-Aldrich. Hydrochloric acid (HCl, 36%) were purchased from Honeywell. Ultrapure grade nitric acid (HNO₃, 60%) was purchased from Kanto Chemical Co. Inc. Deionized (DI) water was obtained from 18.2 MΩ Millipore water purification system. Commercial dimensionally stable anode (DSA) was procured from Anping Tianhao Wire Mesh Products Co., Ltd, Hebei, China. A platinum electrode was purchased from Gaoss Union, Tian Jin Province, China. All chemicals were used without further purification. Carbon dioxide (CO₂, 99.995%) and nitrogen (N₂, 99.995%) were acquired from Leeden Nation Oxygen, Singapore. Desalination brine and natural seawater, obtained from Tuas Desalination Plant, Singapore (GPS 1.303668665682037, 103.62407779717506), were used after filtering with 5.0 μm cellulose nitrate filter paper—its composition is detailed in Table 1.

### Example 1

The multi-waste treatment and resource recovery system 200 involves three (3) pre-treatment reactors (the first reactor 20 (R1), the second reactor 30 (R2), and the third reactor 40 (R3)), followed by membraned electrolysis and utilisation of electrolysis products to circularise the input requirements of R1 (see FIG. 2). R1 and R2, which involve hydroxide precipitation and CO₂ mineralisation, respectively, remove the majority of the multivalent cations such as magnesium, calcium, strontium, aluminium and iron cations to ppb level. Hydroxide precipitation in R1 removes magnesium ions and trace amounts of transition metal ions, and produces white magnesium hydroxide precipitates (Mg(OH)₂), separated via phase separation (i.e. filtration).

R2 outputs mainly calcium carbonates solids and captures CO₂ from industrial flue gas with high CO₂ content. CO₂ mineralisation in R2 further lowers calcium and strontium ions. Simulated flue gas 70 used contains 20% CO₂ and 80% N₂. These precipitation techniques reduce multivalent ions concentration, which can impede electrolysis efficiency in the cathode. R3 acidifies a portion of R2 brine with HCl to lower Cl₂ solubility and remove carbonates, which impede extraction of chlorine gas.

The treated seawater from R2 is diverted into the cathode compartment 51, while treated desalination brine from R3 is utilised in the anode compartment 52 for CER. Hydrogen and chlorine gases were extracted through electrolysis, and hydroxide ions build up in the cathode. The remainder of the alkali catholyte is recycled into R1 for hydroxide precipitation and subsequent carbonate formation. By removing chloride ions from treated brine through CER, the brine concentration is lowered to seawater levels.

The anode brine is dechlorinated by sparging with air and by adding mild reducing agents such as sodium bisulfite. Subsequently, the dechlorinated brine is mixed with catholyte output and neutralised, to be safely discharged into the sea or reverted into the desalination plant. The remainder of the alkali catholyte is recycled into R1 for hydroxide precipitation and subsequent carbonate formation. This lowers the environmental impact of brine discharge by lowering the salinity or remove discharge.

### Example 2

The pre-treatment processes, carbon capture and products recovery of the system described in Example 1 were investigated.

### Hydroxide Precipitation (R1)

Natural seawater and desalination brine were filtered with 5.0 μm cellulose nitrate filter paper (Sartorius Ag, Germany) to remove solid residuals and stored in 2 L bottles. Sodium hydroxide or potassium hydroxide pellets of designated mass were added to filtered brine, resulting in the immediate formation of white precipitates, predominately comprised of Mg(OH)₂. The mixture was stirred at 200 rpm at ambient temperature for 15 min before it was left to settle for 4 h. When the white precipitates, Mg(OH)₂ and Ca(OH)₂, were settled, the solution was carefully filtered with 5.0 μm filter paper to be used for CO₂ mineralisation. The residual mixture was transferred into 50 mL centrifuge tubes and the solids were separated via centrifuge at 5000 rpm for 5 min. To wash the precipitates, DI water was added to the solids remaining in the centrifuge tubes, mixed and centrifuged at the same condition as previously stated. Precipitates were washed 5 times before drying at 115° C. for 24 h in an oven, unless otherwise stated.

### CO₂ Mineralization (R2)

Alkali brines produced via hydroxide precipitation were bubbled with 20% CO₂ and 80% N₂ at a rate of 1 L per min to simulate flue gas composition. pH was monitored and the mineralisation process was halted at pH 10.20. The white carbonate precipitates formed, CaCO₃ and SrCO₃, were extracted via filtration with 5.0 μm filter paper. The filtered solution was used for electrolysis or subjected to acidification. The collected precipitates were washed similarly to hydroxide precipitates.

### Acidification (R3)

To ensure the complete removal of dissolved carbonates, which can interfere with chlorine evolution, approximately 16 mL of 36% HCl concentrated acid was mixed with 2 L carbonated brine to reach pH 2. The acidified brine was degassed using an ultrasound bath at room temperature for 15 minutes.

### Characterisation Methods

Elemental analysis of the electrolytes was performed using an Inductively Coupled Plasma Optical Emission Spectrometer (ICP-OES, Optima 8300, Perkin Elmer), Inductively Coupled Plasma Mass Spectrometer (ICP-MS, iCAP Q, ThermoFisher) and IC (ICS-1100, DIONEX). The combination of elemental analysis techniques allows for analysis over a very large concentration range (50 ppb to 500 ppm for cations, 0.5 ppm to 500 ppm for anions). All samples were diluted 100 times to limit the higher elemental concentration to below 500 ppm. pH and conductivity of brine were measured using a Mettler Toledo SevenGo Duo meter. Hydrogen evolved was characterised using gas chromatography (GC, Agilent Technologies 7890B GC system). pH and conductivity were investigated parameters as they can be continuously monitored in continuous reactors for pre-treatment and electrolysis. pH directly reflects the expected quality of the precipitates, likely yield and the blockage rate in the cathode and faradaic efficiency in the anode. Conductivity was closely monitored to analyse the expected performance in the electrolyser and to observe the lowering of total dissolved solids through the process. Total organic carbon/total nitrogen (TOC/TN) analysis was performed using a Shimadzu TOC-L with ASI-L autosampler. This illuminates the organic carbon (biological organic material or antiscalants) concentration, and organic and inorganic nitrate concentration. Organic and inorganic carbon undergoes oxidation and acid-base reaction with chlorine, respectively, limiting gas phase separation and lowering chlorine gas yield. Total nitrogen must be low or entirely made up of nitrate as chlorine can react with low oxidation state nitrogen to form explosive NCl₃. The precipitates were digested with HNO₃ ultrapure grade acid and were similarly analysed with ICP-OES, ICP-MS and IC. These precipitates were also subjected to XRD (Shimadzu Powder), thermogravimetric analysis (TGA) and differential scanning calorimetry (DSC, Simultaneous Thermal Analyser, STA 449 F3 Jupiter). XRD elucidate the crystal structure and potential applications of precipitates. TGA reveals the thermal property, stability and impurity for alternative applications. FESEM images were taken using JOEL JSM-7200F with Oxford Aztec Standard X-max80 energy dispersive spectrometer (EDS) at an accelerating voltage of 5 kV (without EDS, minimised charging) and 10 kV (with EDS).

### Results and Discussion

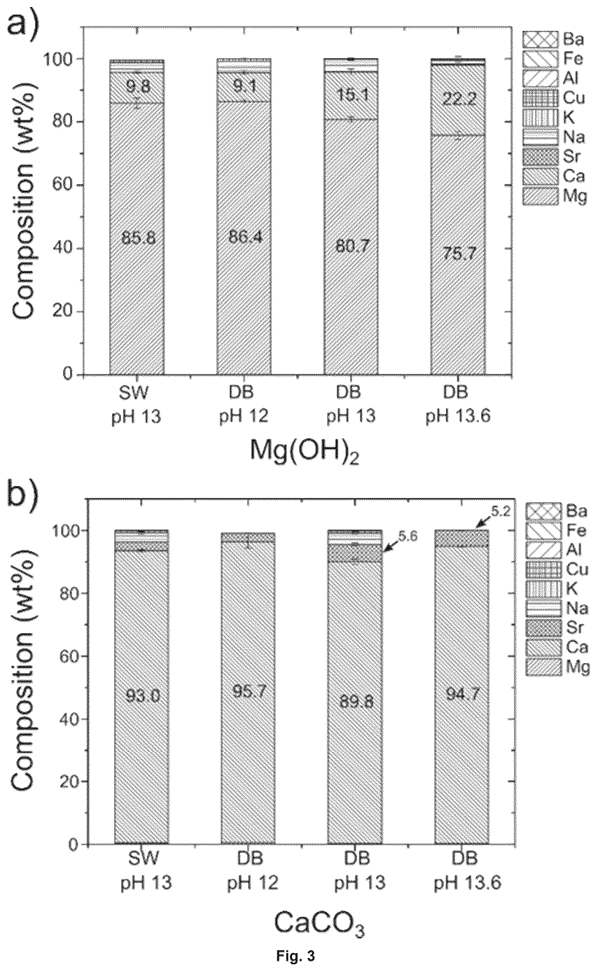

In R1, hydroxide precipitation produces fine, white Mg(OH)₂ suspensions, while CO₂ mineralisation produces high-purity, white CaCO₃ precipitates in R2. The precipitates were removed separately and washed with DI water via centrifuge at 5000 rpm for 10 min. After drying, the precipitates were analysed with ICP-OES and ICP-MS (see FIG. 3). The precipitate compositions were investigated against the stabilised pH after adding NaOH (R1 pH). This pH value can estimate the remaining multi-valent ions based on the solubility product and reflect the amount of CO₂ captured per unit volume.

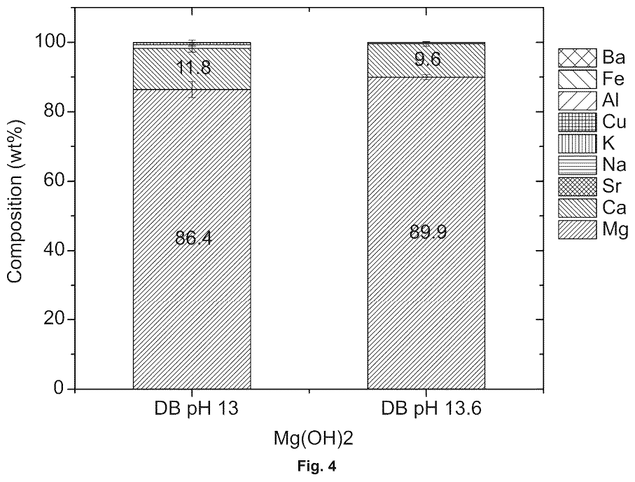

The removed elements were reflected in the R1 hydroxide precipitates, which were predominately made up of 76.4-86.4% Mg(OH)₂, with Ca²⁺ ions contributing to between 9.1% to 15.6% of the cations in the precipitate (see FIG. 3a). At higher pH in R1, a higher percentage of Ca from brine was precipitated together with Mg, leading to decreasing purity of Mg(OH)₂. The Na⁺ were residual NaCl from extraction process, which can be largely removed with more washing cycles (see FIG. 4). Other trace elements account for less than 1% of the precipitate mass.

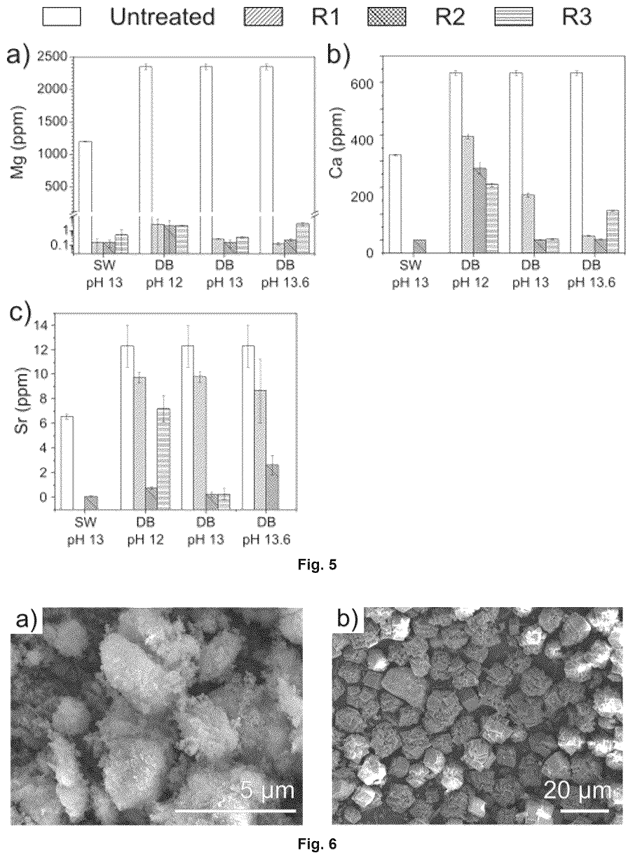

In order to validate product distribution from hydroxide precipitation (using NaOH pellets), several different R1 pHs were investigated to analyse the pre-treatment processes. After R1 precipitation, a series of resulting mixture containing pH 12, pH 13 and pH 13.6 were obtained (refer to Table 2 for mass of NaOH added). In R1, Mg²⁺ ions were removed from desalination brine to below 5 ppm when the brine was treated to pH 12, and below ppm levels for pH 13 (see FIG. 5a). Ca²⁺ ions were also removed in R1 (see FIG. 5b) as the Ca²⁺ content decreased from 636±9 ppm (untreated) to 393±10 ppm (DB pH 12), 171±9 ppm (DB pH 13), and 16.5±0.6 ppm (DB pH 13.6).

TABLE 2
Mg and Ca concentrations in catholyte
and anolyte after electrolysis.

| Conditions | | Mg (ppm) | Ca (ppm) |
|---|---|---|---|
| 100 mA cm⁻² | Catholyte | <0.1 | 0.3 ± 0.1 |
| 6.5 h | Anolyte | 1.8 ± 0.5 | 2.6 ± 0.1 |
| 200 mA cm⁻² | Catholyte | <0.1 | 0.5 ± 0.2 |
| 3.5 h | Anolyte | 2.4 ± 0.2 | 19.0 ± 6.0 |
| 200 mA cm⁻² | Catholyte | <0.1 | 1.2 ± 0.9 |
| 8 h | Anolyte | 0.5 ± 0.1 | 16.6 ± 4.0 |

In R2, the remaining aqueous hydroxide ions in R1-treated brine reacted with acidic CO₂ from simulated flue gas (^{~}20% CO₂) to about pH 10.33 (the pKa₂ value of carbonic acid), providing the highest concentration of carbonate ions (Lide, D. R. CRC Handbook of Chemistry and Physics; CRC press, 2004; Vol. 85). As shown in FIG. 5b, the Ca²⁺ concentration decreased first by about 40% in pH 12 R1 treated brine and about 73% in R1 pH 13 treated brine. When pH 13.6 brine was used, 97.4% of the Ca²⁺ ions would be removed in R1, leading to the lowest carbonate precipitate yield in R2. Through R2, the concentration of Ca²⁺ was removed to around 0.61±0.17 ppm in DB pH 13.

As Mg²⁺ were mostly removed in R1, the carbonate precipitates obtained consisted of 90-95% Ca²⁺, as presented in FIG. 3b. Interestingly, strontium (^{~}12 ppm in desalination brine) was co-precipitated during the CO₂ mineralisation stage at R2, amounting up to 5.6% of total cations in the carbonate precipitates. The strontium in CaCO₃ corresponded to the decrease in trace strontium concentration in both seawater and desalination brine, as shown in FIG. 5c. The SEM image is shown in FIG. 6b.

In FIGS. 5a and 5b, the Mg²⁺ and Ca²⁺ concentrations both increased in R3 acidification (^{~}9 mL of 37% HCl per litre of brine) with concentrated HCl. One plausible explanation is that at pH 13 and around 0.08 mol dm⁻³ Mg²⁺ concentration, the average Mg(OH)₂ agglomerate size is smaller than 5 μm (made up of about 100-200 nm fibre and lamellar particles) as precipitation occurred with no agitation (Hsu, J.-P. & Nacu, A., Colloids Surf. A Physicochem. Eng. Asp. 2005, 262, 220-231, see FIG. 6a). As a result, some fine-grained Mg(OH)₂ precipitates were not effectively removed through the filtration membrane, leading to incomplete removal of precipitates, and small amounts of magnesium were re-introduced during acidification.

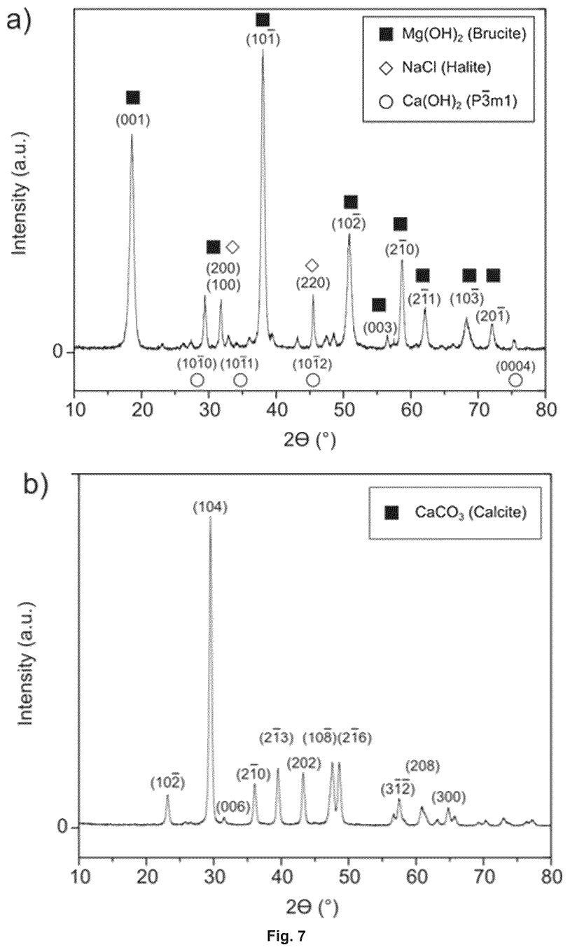

FIG. 3a shows that the Mg(OH)₂ precipitates contained a significant amount of impurities in the form of Ca(OH)₂ and trapped NaCl. For desalination brine, the magnesium hydroxide was composed of about 86 wt % for SW pH 13 and DB pH 12. Increasing to pH 13 resulted in an approximately 10% decrease in Mg(OH)₂. This is mainly due to an increase in Ca(OH)₂ precipitated with the higher concentration of OH. At a pH of 13.6 in R1, the hydroxide precipitates exhibited similar composition as pH 13 when the element standard deviation was considered. The precipitates have varying particle sizes, comprising agglomerations of 100-300 nm elliptical particles that build up to 1-5 μm irregular shapes (see FIG. 6a). The XRD spectra of Mg(OH)₂ precipitates show that the precipitates were made up of a majority of brucite and some halite and P3̅m1 Ca(OH)₂ (see FIG. 7a).

Elemental analysis of CO₂ mineralised products reveal high purity CaCO₃, with most exceeding 90% (see FIG. 3b). The composition is independent of R1 pH changes, but the yield decreases with increasing pH. This corresponds to the increase in Ca(OH)₂ removed at higher R1 pH. Interestingly, strontium was precipitated together with CaCO₃, resulting in a notable contribution to the CaCO₃ composition. This could potentially serve as a method to extract strontium from seawater. The FESEM image shows block-like structures with sharp edges at about 10 to 20 μm in diameter (see FIG. 3b). The XRD spectra of CaCO₃ only has calcite, which corresponds to the elemental composition (see FIG. 7b).

The efficacy of the pre-treatment process was also evaluated through solution elemental analysis after each reactor. As intended, R1 reduced the Mg content to below 1 ppm for DB pH 12 and around 0.1 ppm for DB pH 13 and above (see FIG. 5a). Effective Ca removal was also observed after R2 (see FIG. 5b). As strontium was removed with CaCO₃ in R2 CO₂ mineralisation, it is expected and it was observed a decrease in strontium content remaining in desalination brine after R2 (see FIG. 5c). Occasionally, some multivalent cation precipitates redissolve with the addition of HCl when precipitate removal is incomplete, possibly due to contamination or particle size variation that led to ineffectual solid filtration. Nevertheless, most contaminants were removed to below 5 ppm for DB pH 12 and 1 ppm for DB pH 13. Although the chlor-alkali process demands Mg and Ca contents to be less than 50 ppm, re-designing of electrolysis configuration could increase the low limit to less chemical-intensive levels. As DB pH 13 reached close to chlor-alkali requirements without excessive hydroxide, subsequent experiments were investigated with the DB pH 13 processing method.

pH, conductivity and total dissolved solids (TDS) are recorded in Table 3. Besides variation in pH corresponding to the desired pH control in each reactor, the conductivity and TDS contents reflect the expected electrochemical efficiency based on the literature.

TABLE 3
pH, conductivity and total dissolved solids content
of seawater and desalination brine after each
pre-treatment reactor are presented below.

| | | | Conductivity | Total Dissolved |
|---|---|---|---|---|
| Conditions | | pH | (mS/cm) | Solids (g/L) |
| Seawater | Filtered | 7.77 ± 0.01 | 43.7 ± 0.1 | 32.8 ± 0.08 |
| | R1 | 13.39 ± 0.01 | 95.5 ± 0.1 | 71.6 ± 0.08 |
| | R2 | 10.71 ± 0.01 | 58.3 ± 0.4 | 43.8 ± 0.3 |
| Desalination | Filtered | 7.87 ± 0.02 | 79.1 ± 0.1 | 59.3 ± 0.04 |
| Brine | R1 | 13.15 ± 0.03 | 110.6 ± 0.2 | 83.0 ± 0.15 |
| | R2 | 10.46 ± 0.01 | 87.9 ± 0.1 | 65.9 ± 0.09 |
| | R3 | 2.18 ± 0.01 | 94.5 ± 0.1 | 70.9 ± 0.04 |

In chlor-alkali industry, the operational requirements for Mg²⁺ and Ca²⁺ concentration are below 50 ppb for long-duration operations in 32% NaOH anolyte. Theoretically, it could still result in Ca(OH)₂ precipitation at about 2 ppb Ca and Mg(OH)₂ at below ppb Mg level based on Kₛₚ calculations. However, at extremely low concentration, mass accumulation rate is likely to be so low that there are no observable changes in current between maintenance cycles. As the anolyte stream is recycled in chlor-alkali plants, the accumulation of Mg and Ca could occur with subsequent replenishment of rock or solar salts. Thus, the 50-ppb limit was necessary for industrial-scale operation. At pH 13.5, we expect the lower limit to be approximately 25 times (1.26 ppm) based on the extrapolation of chemical equilibrium from impurity tolerance limit and hydroxide concentration; tolerance limit factor=conc. of NaOH in 32% NaOH/conc. of NaOH in pH 13.5×50 ppb=1.26 ppm. Hence, the concentration of Mg and Ca in the present disclosure is not a cause of concern with subsequent electrolysis.

### Example 3

The feasibility of treated desalination brine for electrolysis resource recovery depends on three important electrochemical properties: high faradaic efficiency; low overpotential; and good membrane stability. For the electrochemical analysis, desalination brine with R1 output pH of 13, dubbed (DB pH 13), was investigated because the multivalent ions were removed to the new impurity tolerance limit based on the previous extrapolation in Example 2.

### Electrochemical Cell Construction

A three-electrode system was constructed with a 100 mL H-type cell. The anolytes and catholytes were separated with Nafion 211 membrane (Gaoss Union, acquired from DuPont). Before use, the Nafion membrane was pre-treated with a cleaning solution containing 5% H₂O₂ at 60° C. for 1 h. When not in use, the Nafion membrane was submerged in DI water. The Nafion 211 membrane is a thin PTFE membrane with sulfonate ion channels (~25.4 μm). The thin membrane has lower membrane resistance, but lower yield stress and ion separation capabilities. Optimisation of the system based on one of the mechanically weaker membranes can allow room for increased ion separation and membrane strength through commercially available materials. For CER analysis, DSA, Pt and 3M-KCl Ag/AgCl electrodes were used as the working, counter and reference electrodes, respectively. For HER analysis, the Ni electrode was used as the working electrode while DSA was the counter electrode. When not in use, Ni electrodes were submerged in 1% HCl solution and 3M-KCl Ag/AgCl electrode was kept in 3 M KCl solution. DSA is the industrially used electrode due to their high corrosion resistance with known CER faradaic efficiency (~94%, pH 2). Pt is a counter electrode with known performance in an alkaline medium. The experiments provide a baseline to compare against other industrially common electrocatalysts.

### General Electrochemical Methods

Electrochemical measurements were performed and repeated on two electrochemical workstations (Gamry Interface 1000 and VersaSTAT 3F, Princeton Research Instrument) at atmospheric pressure. All potentials were measured in Ag/AgCl reference electrode. For HER discussion, the potentials were converted into a reversible hydrogen electrode (RHE) using E (RHE)=E (Ag/AgCl)+0.059×pH+E⁰ (Ag/AgCl), where E⁰ (Ag/AgCl)=0.1976 V. Cyclic voltammetry (CV) was utilised to clean and homogenise the solution at a scan rate of 1000 mV s⁻¹ for 50 cycles between 0.05 and 0.8 V. All electrochemical measurements were performed in triplicate, and the average values were used unless otherwise stated. For hydrodynamic Cl₂ detection, the CER activity was measured using iodometric titration. Before measuring the CER activity, linear scanning voltammetry (LSV) analyses were conducted from 0 to 2.3 V at a scan rate of 10 mV s⁻¹. iR compensates were calculated using the potentiostat' in-built DC-based Rᵤ measurement before every CER activity measurement. The iR compensated potentials (E-iR) were used to remove the impact of solution resistance from the reported potentials. With known solution and other resistances based on electrolyser design, the iR potential increase can be included for overall cell potential estimation. CVs were conducted from 0 to 1.3 V at a scan rate of 10 to 50 mV s⁻¹. The Cl₂ selectivity of the solution was investigated by running chronoamperometry (CA). No stirring was enabled to accurately determine the faradaic efficiency (FE) of Cl₂ at low current density. At high current density, both anode and cathode chambers were stirred with magnetic stirrers at 600 rpm to reduce the resistance effect of bubbles. Each electrochemical chamber contained 100 ml of solution. 90 ml of solution was titrated while the remaining 10 ml was stored for ICP-OES, ICP-MS and IC analysis.

Immediately after completing CA, 10 mL of anodic electrolyte was gently transferred into a glass bottle containing 20 mL of 0.01 M or 0.1 M NaI (in excess over ^{~}100×). This minimises the escape of volatile I₂ at equilibrium concentration. Nine titrations were conducted for a single CA measurement, and the average titration volume was used for FE calculation. Upon mixing the solution, the colourless NaI solution rapidly turned yellowish brown, indicating the formation of I₂.

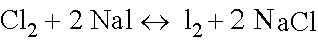

I₂ solution was titrated with standardised 0.01 M or 0.05 M Na₂S₂O₃ solution. When the yellow colour turned pale, a few drops of 1 wt % starch solution were added, turning the solution dark blue and resuming the titration. Two Na₂S₂O₃ molecules are oxidised per I₂ molecule. Hence, the Cl₂ yield can be calculated using the following equation.

$${Cl}_{2} Yield ( mol ) = [ N {a}_{2} {S}_{2} {O}_{3} ] ( M ) \times {V}_{N {a}_{2} {S}_{2} {O}_{3}} ( L ) / 2$$

Iodometric titrations are a well-established active chlorine quantification technique at low concentrations (0.001 M to 0.1 M, 100 mL). This limits CER analysis to around an hour so that the active chloride concentrations do not exceed reasonable chemical requirements. Long-duration experiments to observe chloride removal capability produces 0.4-0.6 M in 100 mL, thus IC analysis was utilised instead. Gaseous products produced at the cathode were collected using a gas bag with a N₂ flow rate of 10 mL min⁻¹ for 1 h. The mol % of H₂ in the collected gas bags were analysed using GC with dual thermal conductivity detectors. The GC was calibrated using different concentrations of calibrations standards with H₂, CO and CH₄. The FEs of H₂ production were calculated with the equations below:

$${FE}_{s} = \frac{2 F {p}_{0} {v}_{s} t G \times 0.00006}{R {T}_{0} {q}_{total}} \times 100 \%$$

Where vₛ (vol %)=volume concentration of s=H₂ in the exhaust gas from the electrochemical cell, p₀=101300 Pa, T₀=298.15 K, outlet gas flow rate (G) measured by Alicat Scientific mass flow meter and confirmed with a rotor meter at the exit of an electrochemical cell (mL min⁻¹), total charge (qₜₒₜₐₗ, C) computed using Gamry analytics' integral function, F=96485 C mol⁻¹, and R=8.314 J mol⁻¹ K⁻¹. The constant is for unit conversion of gas flow rate to SI units.

### Results and Discussion

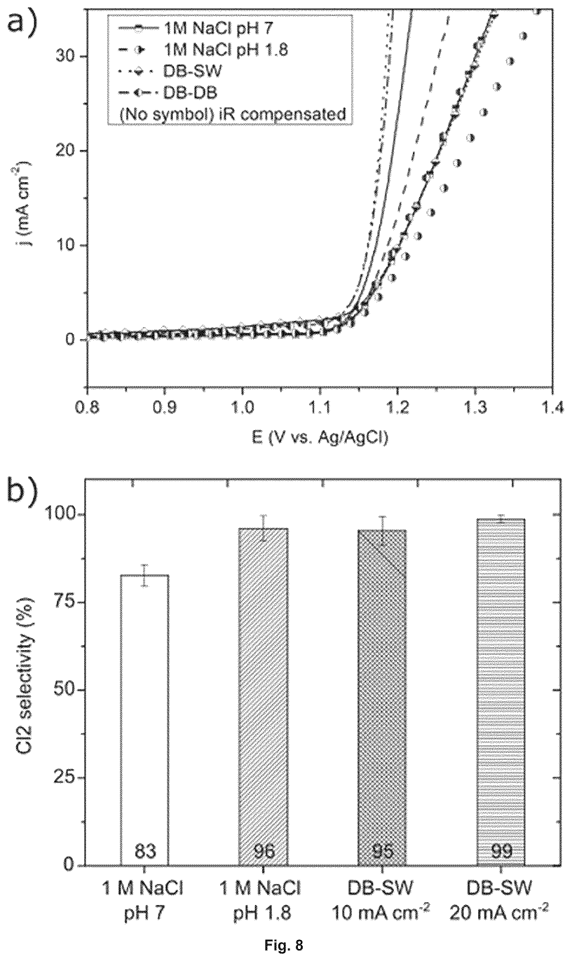

Instead of dismissing the possibility of CER electrolysis at desalination brine concentration, we re-investigated the CER faradaic efficiency with RuO₂/IrO₂ on Ti electrodes. LSV provided details on the overpotential in different electrolytes (see FIG. 8a). The onset potential between control (1 M NaCl pH 7 and pH 2), desalination brine anolyte and desalination brine catholyte (DB-DB) set up, and desalination brine anolyte and seawater catholyte (DB-SW) set up are presented thusly (see FIG. 8). All experiments were triplicate averaged. Considering electrochemical cell resistance, iR compensated graphs (dotted lines) show that DB-DB and DB-SW require slightly lower overpotential to reach 20 mA cm⁻² than 1 M NaCl pH 7. This is likely due to higher conductivity in pre-treated desalination brine than in the control. As the conductivity of pre-treated desalination brine is only about 50% of saturated NaCl, it is not expected to deal a significant difference in overpotential to reach operational current in close or zero gap cells.

Desalination brine-based electrolytes perform at higher current density than 1 M NaCl control using RuO₂/IrO₂ mix metal oxide electrode at pH 1.8. Meanwhile, anolyte-catholyte pairing derived from desalination brine (DB-DB) has very subtle difference compared to the electrolyte system with treated brine in the anode and seawater in the cathode (DB-SW). Both systems were explored to ascertain the impact of osmotic pressure on the stability of the ion exchange membrane. The iR compensated LSV curve provides a comparison with zero-gap electrochemical systems with negligible electrolyte resistance.

CER FE was observed at 80% for 1 M NaCl pH 7 control via iodometric titration. When the pH was decreased to pH 2, DB-DB, DB-SW and 1 M NaCl control electrolyte systems all achieved close to 99% FE after 1 h chronoamperometry. These results differ from similar literature, which predicts 94-96% FE (O'Brien et al., Handbook of Chlor-Alkali Technology: Volume I: Fundamentals, Volume II: Brine Treatment and Cell Operation, Volume III: Facility Design and Product Handling, Volume IV: Operations, Volume V: Corrosion, Environmental Issues, and Future Developments; Springer US, 2005). The precision of iodometric titration is ±1.33%, which could partially account for the disparity. However, the actual reasons might be different. We postulated that at pH 2, the actual FE is close to 100%, but the low solubility of chlorine in acid brine results in gas loss, which is difficult to account for, leading to underestimation in experimental analysis. Conversely, real electrolysers have current efficiency loss due to dissolved chlorine that could not escape the solution to be extracted through phase separation. Extraction enhancement with ultrasonic degasser may improve current efficiency and chlorine extracted. Further, the excess H⁺ ions likely favour the reduction pathway in OER reaction equation, thus limiting OER and promoting higher FE for CER. The complex brine solutions adhere to this trend, producing near 100% FE at 10 and 20 mA cm⁻².

However, this high efficiency drops quickly when the chloride concentration decreases close to the seawater level. SW-SW setup only has a CER FE of 89.6%. The decrease in FE occurs during long-duration experiments (7 h, 200 mA cm⁻²) and presents a problem for the effective removal of chloride. After the long-duration experiment, the calculated FE based on the charges required to remove chloride ions showed only 70.9% chlorine selectivity. The significantly lower FE can be attributed to the poor anion separation capability of Nafion 211 when the catholyte reached above pH 13.3. The anolyte pH increased to pH 10 as a result. The hydroxide reacts with dissolved chlorine to form hypochlorite and chloride ions. Prototype stage design of a continuous flow system will enable flow rate control, keeping the anolyte at pH 2. Moreover, novel CER catalysts can overcome the lower FE at seawater concentration.

HER LSV curves were similarly presented in FIG. 8b. The potential was compared against Ag/AgCl electrode to estimate overall applied potential. Negligible Rᵤ was measured by the potentiostat for HER LSV curves. In general, seawater derived electrolyte has similar LSV curve as 1 M NaCl at different alkaline pH despite lower conductivity. Acidic SW-DB lowers onset potential. HER FE using Ni was about 87% in 10 mA cm⁻² and around 100% for both 20 mA cm⁻² and 100 mA cm⁻².

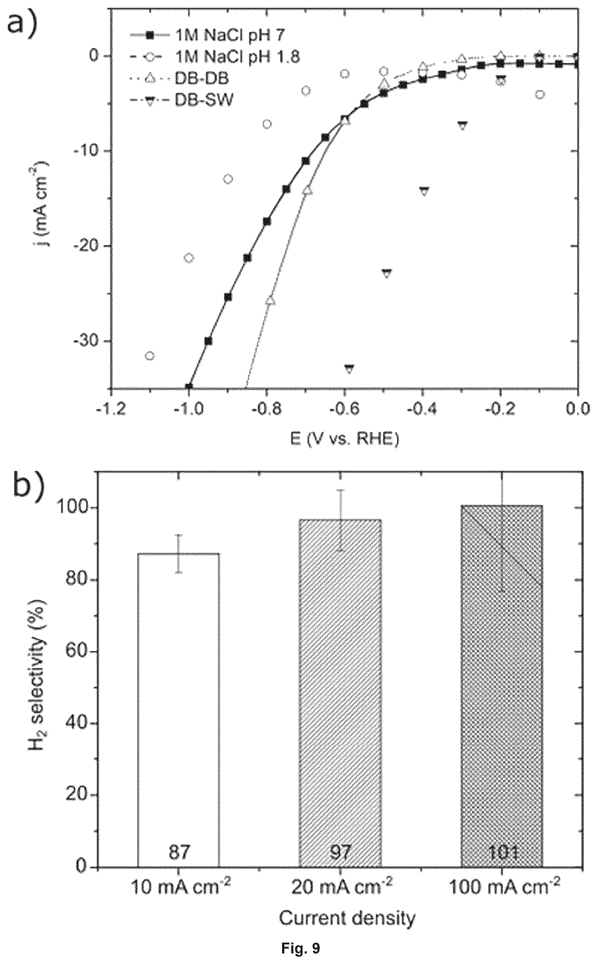

HER presented used Pt foil as catalyst and desalination brine or seawater as catholyte. LSV curves in FIG. 9a showed widely varying onset potential for CER. The high onset potential is due to the high pH using a catalyst which performs optimally in acid conditions. The potentials required to reach 10 mA cm⁻² do not correspond to the catholyte conductivities. Nonetheless, a −350 mV overpotential for DB-SW setup to reach 10 mA cm⁻² serves as a baseline for future analysis of HER electrocatalyst using our electrochemical cell.

The HER FE was above 97% for 20 mA cm⁻² and 100 mA cm⁻² (see FIG. 9b). The FE for 10 mA cm⁻² was only 87%, which might suggest an alternative reaction as the electrolyte contains about 0.05 M CO₃²⁻. However, a preliminary investigation into CO₂ reduction reaction products with NMR and GC did not reveal any notable by-products. Additionally, GC characterisation is slightly problematic and can cause high deviation between replicates, due to low precision of GC (0.1% H₂) and fluctuating outlet gas flow rate.

### Example 4

Aside from conductivity and faradaic efficiency problems, osmotic pressure imbalance is another crucial concern that must be addressed for a functional electrolysis system.

### Long-Duration Chronoamperometry (CA)

Long-duration CA experiments were conducted using two electrochemical workstations (Gamry Interface 1000, and VersaSTAT 3F, Princeton Research Instrument) at atmospheric pressure. CA fixes the applied potential and measures the current with respect to time. Conductivity measurements were made using Mettler Toledo SevenGo Duo meters to determine changes in conductivity and total dissolved solids before and after the experiments.

### Results and Discussion

Long-duration CA experiments reveal that the DB-DB system resulted in a significant change in salinity across the Nafion 211 membrane and caused rupture within 1 h of electrolysis at 100 mA cm⁻², when brine chloride concentration was reduced close to seawater level. Consequently, the DB-SW system was adopted to investigate chloride desalination capabilities (i.e. the stability of the electrolyte (DB-SW), membrane and electrode via chronoamperometry at high current densities of 100 and 200 mA cm⁻²).

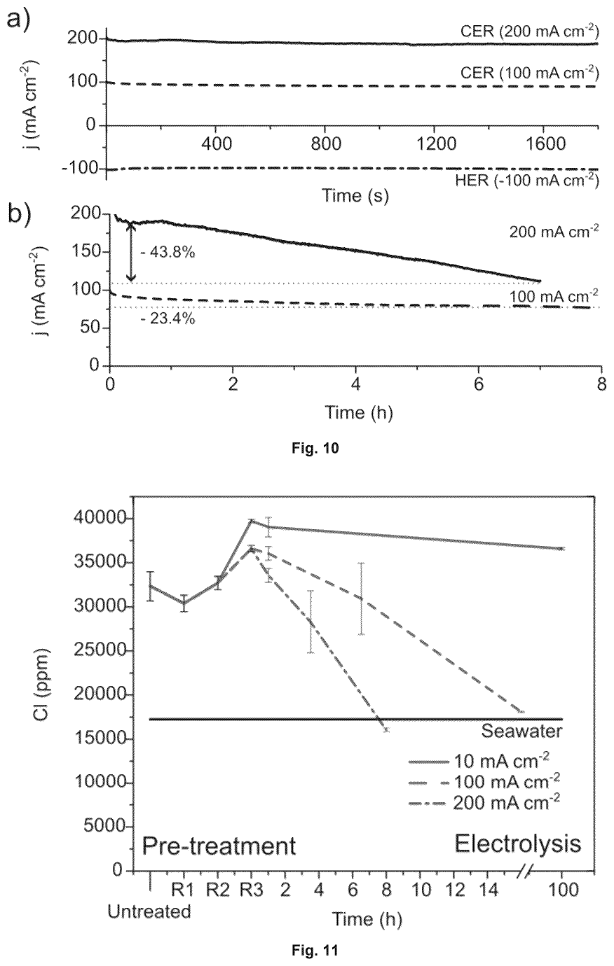

Electrolyte stability was first demonstrated with 1 h experiments at 100 mA cm⁻², 200 mA cm⁻² for CER and 100 mA cm⁻² for HER (see FIG. 10a). As shown in FIG. 10a, the initial current drop did not exceed 5 mA cm⁻² in the first 1-2 min for both current densities, which is likely due to the increased solution resistance by gas evolution. The current density dropped to around 89.9% (100 mA cm⁻²) and 94.4% (200 mA cm⁻²) over 30 min for CER. No current drop was observed HER over 30 min.

7- and 8-hour experiments at 200 mA cm⁻² and 100 mA cm⁻² (2 cm² electrode), respectively, demonstrate the current variations at high current density with respect to time (see FIG. 10b). Long-duration CA curves (see FIG. 10b) show current drops of 23.4% and 43.8% for 100 mA cm⁻² and 200 mA cm⁻², respectively. Accounting for the initial current drop, the current drop appears to scale linearly with time when compared to the 30 min analysis (see Table 4). Further, for 200 mA cm⁻², it was observed that the conductivity decreased by 42.5% and chloride concentration decreased by 56.2%. We attributed the current drop to the corresponding 42.5% reduction in conductivity (see Table 4) to chloride removal. This suggests that the presence of the sulfate prevents an excess decrease in conductivity, maintaining TDS and osmotic balance across the membrane.

TABLE 4
pH, conductivity and total dissolved solids parameters
of each pre-treatment process and electrolytes
from chloride removal experiments.

| | | | Conductivity | Total Dissolved |
|---|---|---|---|---|
| Conditions | | pH | (mS/cm) | Solids (g/L) |
| Seawater | Filtered | 7.77 ± 0.01 | 43.7 ± 0.1 | 32.8 ± 0.08 |
| | R1 | 13.39 ± 0.01 | 95.5 ± 0.1 | 71.6 ± 0.08 |
| | R2 | 10.71 ± 0.01 | 58.3 ± 0.4 | 43.8 ± 0.3 |
| Desalination | Filtered | 7.87 ± 0.02 | 79.1 ± 0.1 | 59.3 ± 0.04 |
| Brine | R1 | 13.15 ± 0.03 | 110.6 ± 0.2 | 83.0 ± 0.15 |
| | R2 | 10.46 ± 0.01 | 87.9 ± 0.1 | 65.9 ± 0.09 |
| | R3 | 2.18 ± 0.01 | 94.5 ± 0.1 | 70.9 ± 0.04 |

DB-SW

| | | | | |
|---|---|---|---|---|
| 100 mA cm⁻² | HER | 13.02 ± 0.01 | 101.8 ± 0.00 | 76.34 ± 0.00 |
| 7 h | CER | 2.15 ± 0.01 | 71.6 ± 0.06 | 53.7 ± 0.04 |
| 200 mA cm⁻² | HER | 13.05 ± 0.01 | 122.1 ± 0.00 | 91.58 ± 0.00 |
| 3.5 h | CER | 1.40 ± 0.00 | 74.0 ± 0.00 | 55.5 ± 0.00 |
| 100 mA cm⁻² | HER | | | |
| 16 h | CER | 12.30 ± 0.03 | 59.0 ± 0.17 | 44.3 ± 0.13 |
| 200 mA cm⁻² | HER | 13.29 ± 0.02 | 130.1 ± 0.14 | 97.58 ± 0.11 |
| 8 h | CER | 4.33 ± 0.02 | 54.3 ± 0.00 | 40.7 ± 0.00 |

There was a slight decrease in Mg²⁺ and Ca²⁺ content in the cathode after electrolysis, suggesting precipitation has occurred despite having no attributable current drop in FIG. 10b. Meanwhile, the Mg²⁺ and Ca²⁺ concentrations remain relatively constant in the anode (see Table 2). Due to the difference in trace divalent ion concentration, we postulated that there is no membrane blockage and precipitation only occurred on the cathode or in the cathode chamber. The exact implication of precipitation may require a scaled-up system for further study.

### Example 5

The chloride removal capability of the system (described in Example 1) is summarised in FIG. 11. By operating at 200 mA cm⁻² (low-ended chlor-alkali electrolyser operational current density), we have lowered the TDS of desalination brine from 70.85±0.04 g/L to 44.25±0.13 g/L (see Table 4). IC analysis showed that the chloride concentration decreased from 35 g/L to 18 g/L through this process. Removal of chloride via CER is able to reach seawater concentration at 100 mA cm⁻² and 200 mA cm⁻² in 16 and 8 h, respectively (see FIG. 11). This desalination capability of brine electrolysis can be leveraged to revert desalination brine into seawater. With a flow system prototype design, desalination can operate at a significantly higher current with larger electrode surface area.

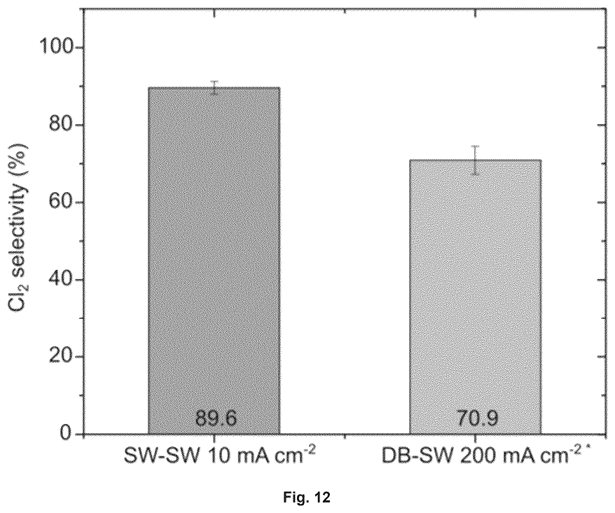

The apparent inefficiency in TDS removal was due to poor hydroxide separation. Anode pH increased to pH 12.3±0.1 for 200 mA cm⁻² for 8 h and to pH 4 for 100 mA cm⁻² for 16 h owing to thin Nafion 211 (25.4±1 μm) membrane selectivity constraints. This had two undesired effects. One was that the chlorine selectivity decreased further than the low chlorine selectivity acid seawater concentration (see FIG. 12). The other was a lowered chloride removal efficacy due to the acid-base reaction between acidic chlorine and basic hydroxide, Cl₂+OH⁻→HClO⁻+Cl⁻. With the dissolving of chlorine, the resultant chloride reduced the current efficiency. Consequently, the current efficiency based on chloride removal was only approximately 70.9% (see FIG. 12). We expect improved performance with thicker 117 NAFION membranes or reinforced chlor-alkali membranes. Moreover, a flow cell system (such as a gas diffusion electrode flow cell) could control different anolyte and catholyte flow rates, thereby preventing the catholyte from exceeding pH 13 by increasing the catholyte flow rates over anolyte flow rates.

After electrolysis, a pH 7-8 feed could be obtained by mixing cathode to anode output, with the final dissolved Cl₂ concentration to be approximately 332 ppm. This anolyte output, acting as biofouling agent, could be reverted into the desalination plant and mixed with seawater to reach effective and acceptable concentrations for polyamide or cellulose acetate membranes (<0.2 ppm Cl₂). To be disposed of into the sea, the toxic dissolved chlorine must be removed with degassing or sodium thiosulfate additives.

### Example 6

### Sustainability Study

The aim of this sustainability simulation was to quantify the global warming potential (GWP, in equivalent CO₂ emission) and brine discharge aquatic ecotoxicity of our system (described in FIG. 1) against past and relevant systems. Sustainability study was performed on openLCA software using ecoinvent 3.0 and EULA product environmental footprint database. Impact analysis utilised environmental footprint method (mid-point) and modified USEtox method as described by Zhou, J. et al., Desalination 2013, 308, 233-241. The simulations generally compartmentalized each system into salt mining, brine treatment and electrolysis. The functional unit was 1 tonne of chlorine produced for GWP100. For aquatic toxicity, 1 tonne of brine was used for relevant comparison with the direct discharge of seawater and desalination brine. The contribution of aquatic toxicity was quantified in Brine Cat 1 (inorganic group), Brine Cat 2 (metal group), and Brine Cat 3 (organic group). The calculation adopted the following assumptions: (i) salinity was estimated with fate factor, persistence time of chemical in the aqueous phase, under the worst-case scenario; (ii) free chlorine content was estimated at 0.5 ppm, below the Singapore trade effluent regulation limit; and (iii) CHBr₃ was selected as the representative organic chemical.

### RESULTS AND DISCUSSION

The environmental impact of the proposed system was investigated with two established LCA parameters: global warming potential 100 (GWP 100); and modified aquatic eco-toxicity (see FIG. 12). To account for the impact of brine, the present disclosure was benchmarked against three different publications' systems (chlor-alkali (Garcia-Herrero, I. et al., Sustain. Prod. Consum. 2017, 12, 44-58), brine-to-chloralkali (Du, F. et al., Environ. Sci. Technol. 2018, 52, 5949-5958), brine-to-chloralkali with CO₂ capture (Choi, W. Y. et al., Desalination 2021, 509, 115068)). For the present disclosure, two scenarios were conceived under GWP 100 analysis. The surplus hydroxide was used to capture more CO₂ in the form carbonates (scenario 1) and bicarbonates (scenario 2). The electrical energy needed was estimated by the sum of iR compensated cathode and anode potentials, and overpotential caused by membrane resistance.

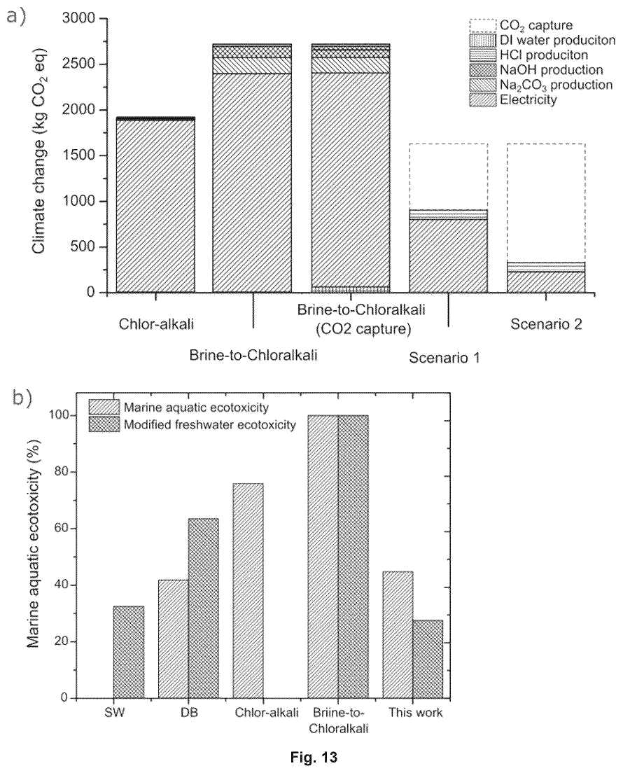

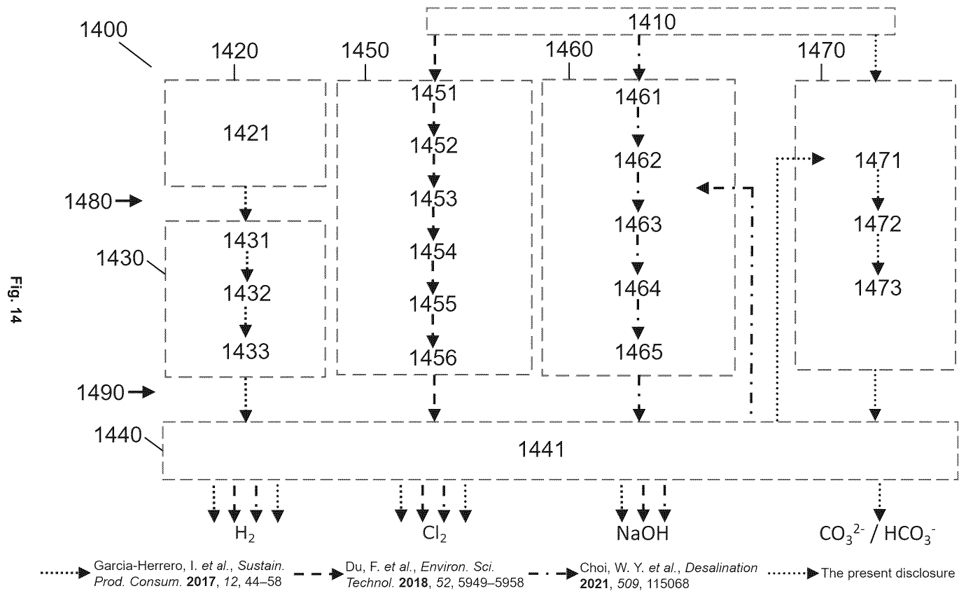

In FIG. 13a, the equivalent CO₂ emission of chlor-alkali process was quantified based on salt mining, brine preparation and electrolysis as described in Garriga et al.'s work (Casas Garriga, S., 2011. Valorization of brines in the chlor-alkali industry. Integration of precipitation and membrane processes (Ph.D. Thesis). TDX (Tesis Doctorals en Xarxa). Universitat Politècnica de Catalunya). Brine-to-chloralkali process with carbon capture had a slightly lower carbon emission than Du et al. (Du, F. et al., Environ. Sci. Technol. 2018, 52, 5949-5958) due to similar brine concentration measures with limited CO₂ mineralisation in the form of MgCO₃ and CaCO₃. Owing to the lower current density and no salt crystallisation in our scenarios, the present disclosure had slightly lower GWP than chlor-alkali plants. We have included 2 scenarios based on capturing the maximum amount of CO₂ in the carbonate form (scenario 1) and in bicarbonate form (scenario 2) with the hydroxide produced for brine desalination to seawater.

For aquatic ecotoxicity, the present disclosure adopted dechlorinated and neutralised brine as the main environmental discharge. The chemical composition was based on the analysed composition of the electrochemical desalinated brine via the 200 mA cm⁻², 8 h experiment. The modified aquatic eco-toxicity showed the quantified impact of desalination brine disposal into the sea. Seawater's aquatic eco-toxicity (14.8 PAF·m3·day) acted as a baseline for comparison. Brine-to-chloralkali system (Du, F. et al., Environ. Sci. Technol. 2018, 52, 5949-5958) disposes of 97.4% of the brine used, with 69.7% discharged as nanofiltration rejects (7.5% TDS), 26.2% as electrodialysis dilute (3.5% TDS) and 1.5% discharge as purged anolyte (30% TDS). As the majority of the reject brine was nanofiltration rejects, the combined aquatic eco-toxicity (^{~}29.7 PAF·m3·day) was only marginally higher than direct desalination brine disposal (28.9 PAF·m3·day). After dechlorination and neutralisation, our brine discharge was at softened seawater concentration, and the ecotoxicity value was calculated at 16.3 PAF·m3·day.

The boundaries of the sustainability study are detailed in FIG. 14 and the mass balance of each component are detailed in Tables 5-7.

TABLE 5
Parameters for salt mining.

| | | | | | |
|---|---|---|---|---|---|
| | | Brine-to- | | | |
| | | chloralkali | | | |
| Chlor- | Brine-to- | (CO₂ | | | |
| alkali | chloralkali | capture) | S1 | S2 | Unit |

Salt mining

| Inputs | Electricity | 0.068 | — | — | — | — | kWh |
|---|---|---|---|---|---|---|---|
| | H₂O | 0.780 | — | — | — | — | kg |
| | NaCl | 2.310 | — | — | — | — | |
| Outputs | Products | | | | | | |
| | NaCl (aq) | 1.94 | — | — | — | — | kg |
| | Effluent | | | | | | |
| | Chlorine | 195 | — | — | — | — | g |
| | H₂O | 0.58 | — | — | — | — | kg |

TABLE 6
Parameters for brine preparation.

| | | | | | |
|---|---|---|---|---|---|
| | | Brine-to- | | | |
| | Brine-to- | chloralkali | | | |
| Chloralkali | chloralkali | (CO₂ capture) | S1 | S2 | Unit |

Brine prep

| Inputs | NaCl (aq) | 1.940 | 21.720 | 21.720 | | | kg |
|---|---|---|---|---|---|---|---|
| | Electricity | 0.000 | 0.949 | 0.949 | 0.152 | 0.152 | kWh |
| | H₂O | 0.220 | 0.000 | 0.000 | 0 | 0 | kg |
| | HCl | 0.028 | 0.027 | 0.027 | 0.0147 | 0.0147 | kg |
| | Na₂CO₃ | 0.012 | 0.287 | 0 | 0 | 0 | kg |
| | CO₂ | — | — | 0.063 | 0.009 | 0.009 | kg |
| | (precipitation) | | | | | | |
| | CO₂ (capture) | — | — | — | 0.426 | 0.851 | |
| | NaOH | 0.0029 | 0.161 | 0.161 | — | — | kg |
| Outputs | Products | | | | | | |
| | NaCl (aq) | 1.94 | 3.507 | 3.507 | 8.1088 | 16.217 | kg |
| | Mg(OH)₂ | — | — | — | 0.398 | 0.398 | Kg |
| | MgCO₃ | — | — | 0.037 | — | — | Kg |
| | CaCO3 | — | — | 0.046 | 0.021 | 0.021 | Kg |
| | Effluent | | | | | | |
| | Brine Cat1 | — | 16.505 | 16.505 | — | — | kg |
| | Brine Cat2 | — | 0.0001 | 0.0001 | — | — | kg |
| | Brine Cat3 | — | 0.0001 | 0.0001 | — | — | kg |
| | Chlorine | 135.00 | — | — | — | — | g |
| | Slag and ashes | 0.0237 | 0.733 | 0.733 | — | — | kg |
| | H₂O | 0.561 | 4.574 | 4.574 | — | — | kg |

TABLE 7
Parameters for electrolysis.

| | | | | | |
|---|---|---|---|---|---|
| | | Brine-to- | | | |
| | Brine-to- | chloralkali | | | |
| Chloralkali | chloralkali | (CO₂ capture) | S1 | S2 | Unit |

Electrolysis

| Inputs | NaCl | 1.940 | 3.507 | 3.507 | | | |
|---|---|---|---|---|---|---|---|
| | Electricity | 2.833 | 2.697 | 2.697 | 2.642 | 2.642 | kWh |
| | H₂O | 2.020 | — | — | — | — | kg |
| Outputs | Products | | | | | | |
| | Cl₂ | 1.000 | 1.000 | 1.000 | 0.4 | | kg |
| | H₂ | 0.030 | 0.031 | 0.031 | 14.2 | | kg |
| | NaOH | 1.127 | 1.180 | 1.019 | — | — | kg |
| | Effluent | | | | | | |
| | Cl₂ | 1.90 | — | — | — | — | mg |
| | Chlorate | 1750 | — | — | — | — | mg |
| | Bromate | 0.18 | — | — | — | — | mg |
| | Brine Cat1 | — | 3.369 | 3.369 | 2.253 | 2.253 | kg |
| | Brine Cat2 | — | 0.0001 | 0.0001 | | | kg |
| | Brine Cat3 | — | 0.0001 | 0.0001 | | | kg |
| | Air emission | | | | | | |
| | Chlorine | 7.50 | — | | | | mg |

FIG. 14 depicts a flow diagram 1400 comprising of sub-systems and processes analysed in the present disclosure and in the literature. In these sub-systems and processes, there is desalination brine 1410. In Garcia-Herrero, I. et al., Sustain. Prod. Consum. 2017, 12, 44-58, there is a salt mining step 1420 which includes KCl waste mining 1421, a brine preparation step 1430 which includes precipitation 1431, ion exchange 1432 and acidification 1433, and electrolysis 1440 which includes a membrane cell 1441. In Du, F. et al., Environ. Sci. Technol. 2018, 52, 5949-5958, there is a pre-treatment step 1450 which includes nanofiltration 1451, electrodialysis 1452, an evaporator or mechanical vapour compression (MVC) 1453, chemical precipitation 1454, ion exchange resin 1455 and acidification 1456, and electrolysis 1440 which includes a membrane cell 1441. In Choi, W. Y. et al., Desalination 2021, 509, 115068, there is a pre-treatment step 1460 which includes an evaporator or MVC 1461, hydroxide precipitation 1462, CO₂ mineralisation 1463, ion exchange resin 1464 and acidification 1465, and electrolysis 1440 which includes a membrane cell 1441. In the present disclosure, there is a pre-treatment step 1470 which includes hydroxide precipitation 1471, CO₂ mineralisation 1472 and acidification 1473, and electrolysis 1440 which includes a membrane cell 1441. Further, these sub-systems and processes involve energy 1480 and materials 1490.

Thus, in the present disclosure, an integrated resource recovery system, dubbed NEWSeawater system, was designed to lower the environmental impacts by treating desalination brine and simulated flue gas into environmentally friendly waste feeds. This was accomplished by electrolysis at lower chloride concentrations (desalination brine, TDS=56 g/L, [Cl⁻]=34 g/L) than chlor-alkali ([NaCl]=280-320 g/L). Seawater was used as the pH 13.4 catholyte, paired with desalination brine as the pH 2 anolyte, to improve current efficiency and maintain osmotic pressure across the ion exchange membrane. The lower catholyte pH compared to chlor-alkali process also raised the impurity tolerance limit of the system. To the best of our knowledge, no one has evaluated the combined potential of brine desalination through electrolysis and electrochemistry of chlorine production from unconcentrated desalination brine in a membraned electrochemical cell. This design can potentially supply chemically softened NEWSeawater as a feed for desalination plants. If not, the system output can offer a safer disposal into the sea after dechlorination and neutralisation. Sustainability assessments on CO₂ emission and aquatic ecotoxicity were also performed to compare our process with established processes in the literature (Zhou, J. et al., Desalination 2013, 308, 233-241). In addition, the system of the present disclosure recovers Mg(OH)₂, CaCO₃, H₂, Cl₂ and Br₂ from desalination brine through brine treatment and electrolysis processes. The input feeds include desalination brine and industrial flue gas, and the discharge outputs contain low CO₂ content and NEWSeawater (softened brine at seawater concentration). CO₂ is captured in CaCO₃ and NaHCO₃ to maximise the CO₂ captured to reach carbon negative.

The present disclosure re-evaluated resource recovery from desalination brine via chlor-alkali process. The pre-treatment system and electrolyte design utilise less purified and unconcentrated desalination brine. This removes the additional energy required to concentrate desalination brine to chlor-alkali concentrations. As the operating catholyte pH is significantly lower than the chlor-alkali process, a thinner and materially cheaper membrane (Nafion 211 or 117) could be used while maintaining equivalent osmotic pressure and membrane charge separation. Utilising thinner and less reinforced membranes further reduce electrolyte overpotential, thereby lowering resistance-induced voltage loss.

Moreover, the chemical requirements to treat desalination brine could be fulfilled by the electrolysis process. The amount of hydroxide needed for chemical precipitation could be generated by the HER process and the excess could be used for water treatment processes in desalination plants. This also act as an active CO₂ capturing process that can remove CO₂ from industrial exhaust wastes. By mineralisation in CaCO₃ and dissolving in aqueous bicarbonate, CO₂ emitted from electrolysis could be offset.

Lastly, the output can be safely disposed of into the sea after dechlorination and neutralisation. This output can also be repurposed as processed feed to desalination plants or other marine feedstock due to the high carbonate or bicarbonate concentration. The capability and consistency of the system warrants upscaling this design and incorporation with novel electrodes with high selectivity and low overpotential.

1. A process for treating a desalination-rejected brine and a flue gas, the process comprising the steps of:
(a) subjecting a desalination-rejected brine to reaction with an alkali metal hydroxide to provide a precipitate comprising magnesium hydroxide and an alkaline brine, and separating the precipitate from the alkaline brine;
(b) bubbling a flue gas comprising CO₂ into the alkaline brine to provide a precipitate comprising calcium carbonate and a softened brine, and separating the precipitate from the softened brine;
(c) subjecting the softened brine to acidification by addition of an acid to provide an acidified brine having a pH of from 1 to 5;
(d) providing the acidified brine to an anode compartment of a flow electrochemical cell and providing a seawater and/or a reclaimed seawater to a cathode compartment of the flow electrochemical cell and generating:
chlorine gas and an anode brine from an electrochemical chlorine evolution reaction; and
hydrogen gas and an alkaline cathode brine from an electrochemical hydrogen evolution reaction; and
(e) mixing the anode brine and the entirety or a third portion of the alkaline cathode brine together and subjecting the mixture to a dechlorination reaction to provide a reclaimed seawater.

2. The process according to claim 1, wherein the process further comprises the steps of:
(a′) subjecting a seawater and/or a reclaimed seawater to reaction with an alkali metal hydroxide to provide a precipitate comprising magnesium hydroxide and an alkaline seawater, and separating the precipitate from the alkaline seawater; and
(b′) bubbling a flue gas comprising CO₂ into the alkaline seawater to provide a precipitate comprising calcium carbonate and a softened seawater with a pH of from 8 to 10, and separating the precipitate from the softened seawater,
where the softened seawater is used in place of, or in addition to, the seawater in step (d) of the process according to claim 1.

3. The process according to claim 1, wherein one or both of the following apply:
(aa) the alkali metal hydroxide is one or both of sodium hydroxide and potassium hydroxide; and
(bb) the pH of the alkaline brine step in (a) of claim 1 is from 11.5 to 13.

4. The process according to claim 1, wherein when the second portion of the second portion of the alkaline chloride brine is used in step (b) of the process it is used to capture CO₂ in the flue gas as sodium bicarbonate.

5. The process according to claim 1, wherein one or both of the following apply:
(A) the acid in step (c) of claim 1 is a mineral acid; and
(B) the pH of the acidified brine in step (c) of claim 1 is from 2 to 4.

6. The process according to claim 1, wherein the dechlorination reaction is conducted using one or more of sparging with a suitable gas and reaction with a suitable dechloriation reagent.

7. The process according to claim 1, wherein one or more of the following apply:
(ia) the weight to weight ratio of the desalination-rejected brine to the alkali metal hydroxide in dry weight form is from 125:1 to 125:2;
(iia) the weight to weight ratio of the alkaline brine to the flue gas is from 40:1 to 100:1; and
(iiia) the weight to weight ratio of the softened brine to acid is from 700:1 to 1000:1.

8. The process according to claim 1, wherein one or more of the following apply:
(ib) the precipitate comprising magnesium hydroxide further comprises calcium hydroxide; and
(iib) the precipitate comprising calcium carbonate further comprises strontium carbonate.

9. An apparatus for treating a desalination-rejected brine and a flue gas, the apparatus comprising:
a first reactor configured to receive a desalination brine and an alkali metal hydroxide to provide a first precipitate and an alkaline brine, and a first separation means or apparatus to separate the first precipitate from the alkaline brine;
a second reactor configured to receive the separated alkaline brine and a flue gas, where the second reactor is configured to allow the flue gas to be bubbled through the alkaline brine to provide a second precipitate and a softened brine, and a second separation means or apparatus to separate the second precipitate from the softened brine;
a third reactor configured to receive the softened brine and an acid in amounts to provide an acidified brine;
a flow electrochemical cell comprising:
an anode compartment for receiving the acidified brine;
a cathode compartment for receiving a seawater and/or a reclaimed seawater; and
an ion-selective membrane between the anode and cathode compartments, wherein the flow electrochemical cell is configured to provide:
chlorine gas and an anode brine from the acidified brine; and
hydrogen gas and an alkaline cathode brine from the seawater and/or the reclaimed seawater; and
a dechlorination reactor to receive the anode brine and at least a portion of the alkaline cathode brine and provide a reclaimed seawater.

10. The apparatus according to claim 9, wherein the apparatus further comprises a fluid pathway to provide at least part of the alkaline cathode brine to the first reactor.

11. The apparatus according to claim 9, wherein the apparatus further comprises a fluid pathway to provide at least part of the reclaimed seawater to the cathode compartment.

12. The apparatus according to claim 9, wherein:
the first reactor is divided into:
a first portion that is configured to receive a desalination brine and an alkali metal hydroxide to provide a first precipitate and an alkaline brine; and
a second portion that is configured to receive a seawater and/or a reclaimed seawater and an alkali metal hydroxide to provide a first' precipitate and an alkaline seawater;
the first separation means or apparatus is divided into a first portion configured to separate the first precipitate from the alkaline brine and a second portion configured to separate the first' precipitate from the alkaline seawater;
the second reactor is divided into:
a first portion configured to receive the separated alkaline brine and a flue gas, where the first portion of the second reactor is configured to allow the flue gas to be bubbled through the alkaline brine to provide a second precipitate and a softened brine; and
a second portion configured to receive the separated seawater brine and a flue gas, where the second portion of the second reactor is configured to allow the flue gas to be bubbled through the alkaline brine to provide a second' precipitate and a softened seawater;
the second separation means or apparatus is divided into a first portion configured to separate the second precipitate from the softened brine and a second portion configured to separate the second' precipitate from the softened seawater; and
a first fluid pathway to provide the softened brine to the third reactor and a second fluid pathway to provide the softened seawater to the cathode compartment.

13. The process according to claim 1, where the alkaline cathode brine generated in step (d) of the process is used in one or both of step (a) and step (b) of the process.

14. The process according to claim 1, where a portion of the reclaimed seawater obtained in step (e) of the process is provided to the cathode compartment in step (c) of the process.
